(19) United States
(12) Patent Application Publication
(10) Pub. No.: US 2026/0244644 A1
(43) Pub. Date: Aug. 20, 2026

(54) ANIMAL HEALTH DATA SYNCHRONIZATION AND ACCESS PLATFORMS AND METHODS OF USING THE SAME

(71) Applicant: Clarus Technology Holdings Ltd., Scottsdale, AZ (US)

(72) Inventors: Dirk BEECKMAN, London (GB); Georgia WRAIGHT, Scottsdale, AZ (US); Ian ROBERTS, London (GB); Craig WHITE, Scottsdale, AZ (US); David MCHUGH, Borehamwood (GB)

(21) Appl. No.: 19/399,406

(22) Filed: Nov. 24, 2025

Related U.S. Application Data
(60) Provisional application No. 63/760,924, filed on Feb. 20, 2025.

(51) Int. Cl. G06F 16/27; G06N 5/022

(52) U.S. Cl. CPC G06F 16/27; G06N 5/022

(57) ABSTRACT

A distributed data synchronization and access platform and method of using the same are provided. An example platform includes at least one platform technology subsystem, which is in operative communication with a plurality of partner systems. The at least one platform technology subsystem is configured to intake data from each partner system of the plurality of partner systems and distribute data to each partner system of the plurality of partner systems. The data intake and the data distribution performed by the platform technology subsystem is agnostic to data content utilized by each partner system of the plurality of partner systems. The at least one platform technology subsystem is configured to store centralized integrated data in a knowledge graph generated based on the data taken in from each partner system.

### CROSS-REFERENCE TO RELATED APPLICATIONS

This application claims priority to U.S. Provisional App. No. 63/760,924, filed on Feb. 20, 2025, and titled “INDUSTRY ECOSYSTEM PLATFORM AND METHODS OF USING SAME,” the contents of which are incorporated by reference herein in their entirety.

### TECHNICAL FIELD

The present disclosure, in some embodiments thereof, relates to the industry ecosystems and, more particularly, but not exclusively, to a system for distributed data synchronization, processing, management and communications for various information providers within an industry ecosystem.

### BACKGROUND

Previous attempts have been made in the pet/animal health industry to facilitate electronic and/or digital communications between different participants in the industry.

A previous attempt includes a system and method implemented to facilitate real-time medical coverage for veterinary hospitals. More specifically, the disclosure as a pet medical insurance system and method utilizes data available in veterinary hospital practice information systems to facilitate real-time insurance enrollment and claims processing.

As another example, previous attempts describe pet insurance systems providing rapid insurance enrollment and quick claim processing. In addition, the pet insurance systems and methods generate a pet health status identifier that is displayed to users of the system.

As another example, a previous attempt describes a system and method implemented to facilitate real-time medical coverage for veterinary hospitals. More specifically, the disclosure as a pet medical insurance system and method utilizes data available in veterinary hospital practice information systems to facilitate real-time insurance enrollment and claims processing.

As another example, a previous attempt describes a system and method implemented to facilitate real-time medical coverage for veterinary hospitals. More specifically, the disclosure as a pet medical insurance and claims system comprising: a backend subsystem implemented on a computer, the backend subsystem comprising a services subsystem; a plug-and-play data integration system connected to a first practice management system in a veterinary practice and the backend subsystem. The plug-and-play data integration system receives data from the first practice management system and maps the data according to the backend system, thereby limiting the data traffic between the backend subsystem and the first practice management system. The plug-and-play data integration system is interoperable with a second or more different practice management systems for receiving data that is different from the data from the first practice management system.

### SUMMARY

In accordance with a first aspect of the disclosure, a distributed data synchronization and access platform is provided. An example distributed data synchronization and access platform includes at least one platform technology subsystem, wherein the at least one platform technology subsystem is in operative communication with a plurality of partner systems. The at least one platform technology subsystem is configured to intake data from each partner system of the plurality of partner systems and distribute data to each partner system of the plurality of partner systems. The data intake and the data distribution performed by the platform technology subsystem is agnostic to data content utilized by each partner system of the plurality of partner systems. The at least one platform technology subsystem is configured to generate one or more synchronized identifiers corresponding to one or more subsets of data associated with an entity, wherein each synchronized identifier of the one or more synchronized identifiers correspond to a data subset of the one or more subsets of data associated with the entity, and store, based on the one or more subsets of data associated with the entity, centralized integrated data, wherein the centralized integrated data is stored in a knowledge graph generated based on the one or more synchronized identifiers.

In some embodiments of the distributed data synchronization and access platform, the platform technology subsystem includes a federated data gateway and one or more computing agents. The federated data gateway provides a data interlink between at least one of the one or more computing agents and at least one of the plurality of partner systems.

In some embodiments of the distributed data synchronization and access platform, the platform technology subsystem includes a federated data gateway and one or more computing agents. The federated data gateway provides a data interlink between different computing agents of the one or more computing agents.

In some embodiments of the distributed data synchronization and access platform, the platform technology subsystem includes one or more computing agents, the one or more computing agents including: an automation agent, or a medical record AI agent, or a temporal knowledge graph agent, or a partner web UI agent, or a normalization agent, or a workflow logic agent, or a simulator and admin configuration agent, or a summarization and inference agent, or a combination thereof.

In some embodiments of the distributed data synchronization and access platform, the at least one platform technology subsystem includes at least one temporal knowledge graph agent that is configured to generate the knowledge graph comprising a temporal knowledge graph from the centralized integrated data, and the temporal knowledge graph accounts for disparate data points from different partner systems of the plurality of partner systems and represented in the centralized integrated data.

In some embodiments of the distributed data synchronization and access platform, the at least one platform technology subsystem includes at least one relationship links agent that manages relationships between one or more synchronized identifiers in the temporal knowledge graph.

In some embodiments of the distributed data synchronization and access platform the at least one platform technology subsystem includes at least one computing agent, and the at least one computing agent is configured to output a determination value based on at least a portion of the centralized integrated data in the knowledge graph.

In some embodiments of the distributed data synchronization and access platform, to intake the data from each partner system of the plurality of partner systems, the platform technology subsystem is configured to generate the centralized integrated data including one or more data episodes comprising one or more timestamped entity relationships and one or more facts derived through at least one normalized data container.

In some embodiments of the distributed data synchronization and access platform, the at least one platform technology subsystem is configured to provide access to at least one service based on the data or requirements taken in from each partner system, the centralized integrated data, or data derived from the data taken in from each partner system or the centralized integrated data.

In some embodiments of the distributed data synchronization and access platform, the knowledge graph comprises at least one node representing the entity and further comprising an interconnection (e.g., an edge) representing a relationship between the entity and another entity, a relationship between the entity and another entity.

In accordance with another aspect of the disclosure, a method of using distributed data synchronization and access platform is provided. An example method includes receiving, at a platform technology subsystem of the distributed data synchronization and access platform, a plurality of intake data, where the plurality of intake data comprises data from each of a plurality of distinct partner systems. The method further includes generating, by the platform technology subsystem, a knowledge graph comprising centralized integrated data based on the plurality of intake data from the plurality of distinct partner systems. The centralized integrated data is corresponding to one or more synchronized identifiers associated with an entity. The method further includes storing, by the platform technology subsystem, the centralized integrated data. The method further includes distributing, by the platform technology subsystem, at least a portion of data based on the centralized integrated data in the knowledge graph to at least one of the plurality of distinct partner systems. The platform technology subsystem performs the receiving of the plurality of intake data and the distributing of at least the portion of data based on the centralized integrated data in the knowledge graph agnostic to data content utilized by each partner system of the plurality of distinct partner systems.

In some embodiments of the method, the platform technology subsystem comprises a federated data gateway, and the federated data gateway provides a data interlink that receives the plurality of intake data.

In some embodiments of the method, the one or more synchronized identifiers are interoperably accessible by multiple of the plurality of distinct partner systems.

In some embodiments of the method, the platform technology subsystem comprises a federated data gateway, and the federated data gateway provide a data interlink that distributes at least the portion of the data based on the centralized integrated data.

In some embodiments of the method, the platform technology subsystem generates the centralized integrated data using one or more of: an automation agent, or a medical record AI agent, or a temporal knowledge graph agent, or a partner web UI agent, or a normalization agent, or a workflow logic agent, or a simulator and admin configuration agent, or a summarization and inference agent, or a combination thereof.

In some embodiments of the method, the method further includes generating, by at least one temporal knowledge graph agent of the platform technology subsystem, the knowledge graph including a temporal knowledge graph from the centralized integrated data, where the temporal knowledge graph accounts for distinct data points from different partner systems of the plurality of distinct partner systems and represented in the centralized integrated data.

In some embodiments of the method, the method further includes managing, by at least one relationship links agent of the platform technology subsystem, one or more relationships between nodes associated with distinct data entities in the temporal knowledge graph.

In some embodiments of the method, outputting, by at least one computing agent of the platform technology subsystem, a determination value based on the centralized integrated data.

In some embodiments of the method, generating the centralized integrated data includes generating the centralized integrated data comprising one or more data episodes comprising one or more timestamped entity relationships and one or more facts derived through at least one normalized data container.

In some embodiments of the method, the method further includes providing, by at least one computing agent of the platform technology subsystem, access to at least one service to at least one of the partner systems, where the at least one service is provided based on the data captured within the knowledge graph.

In accordance with another aspect of the disclosure, a non-transitory computer-readable storage medium is provided. The non-transitory computer-readable storage medium includes computer-coded instructions stored thereon that, in execution with at least one processor, configure the at least one processor. The non-transitory computer-readable storage medium configures the at least one processor for receiving, at a platform technology subsystem of the distributed data synchronization and access platform, a plurality of intake data, where the plurality of intake data comprises data from each of a plurality of distinct partner systems. The non-transitory computer-readable storage medium further configures the at least one processor for generating, by the platform technology subsystem, a knowledge graph including centralized integrated data based on the plurality of intake data from the plurality of distinct partner systems. The centralized integrated data corresponds to one or more synchronized identifiers associated with an entity. The non-transitory computer-readable storage medium further configures the at least one processor for storing, by the platform technology subsystem, the centralized integrated data. The non-transitory computer-readable storage medium further configures the at least one processor for distributing, by the platform technology subsystem, at least a portion of data based on the centralized integrated data in the knowledge graph to at least one of the plurality of distinct partner systems.

In some embodiments of the non-transitory computer-readable storage medium, the computer-coded instructions further configure the at least one processor for generating, by at least one temporal knowledge graph agent of the platform technology subsystem, the knowledge graph including a temporal knowledge graph from the centralized integrated data, where the temporal knowledge graph accounts for distinct data points from different partner systems of the plurality of distinct partner systems and represented in the centralized integrated data.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the disclosure can involve performing or completing selected tasks manually, automatically, or a combination thereof. Moreover, according to actual instrumentation and equipment of embodiments of the method and/or system of the disclosure, several selected tasks could be implemented by hardware, by software or by firmware or by a combination thereof using an operating system.

For example, hardware for performing selected tasks according to embodiments of the disclosure could be implemented as a chip or a circuit. As software, selected tasks according to embodiments of the disclosure could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the disclosure are herein described, by way of example only, with reference to the accompanying drawings. With specific reference now to the drawings in detail, it is stressed that the particulars shown are by way of example, are not necessarily to scale and are for purposes of illustrative discussion of embodiments of the disclosure. In this regard, the description taken with the drawings makes apparent to those skilled in the art how embodiments of the disclosure may be practiced.

In the drawings:

FIG. 1A is system architecture diagram of a real-time distributed data synchronization and access platform, for example embodying an animal health ecosystem platform, in accordance with an exemplary embodiment of the present disclosure;

FIG. 1B is an illustration showing high level concepts touched by an animal health ecosystem platform, in accordance with an exemplary embodiment of the present disclosure;

FIG. 2A and FIG. 2B are a block diagram of a real-time distributed data synchronization and access platform, for example embodying an animal health ecosystem platform, in accordance with an exemplary embodiment of the present disclosure;

FIG. 3 is a workflow diagram of a real-time claims settlement process, in accordance with an exemplary embodiment of the present disclosure;

FIG. 4 is a hybrid block diagram and flowchart showing a real-time claims settlement process, in accordance with an exemplary embodiment of the present disclosure;

FIG. 5A and FIG. 5B are a hybrid block diagram and flowcharts showing a real-time claims settlement process, in accordance with a different exemplary embodiment of the present disclosure;

FIG. 6 is a concept drawing illustrating ecosystem “marketecture” functionality and participants, in accordance with an exemplary embodiment of the present disclosure;

FIG. 7A and FIG. 7B are a schematic diagram showing interrelationships between data elements of various Partners participating in the platform, including a pet, as well as exemplary actions between them, in accordance with an exemplary embodiment of the present disclosure;

FIGS. 8A-8C are a flowchart indicating steps of an example claims processing flow performed by the platform, in accordance with an exemplary embodiment of the present disclosure;

FIG. 9 are an example depiction of a workflow in which a platform as described herein is utilized for point of care coverage determination in accordance with at least an exemplary embodiment of the present disclosure; and

FIG. 10 is an example diagram depicting formation of a knowledge graph for data of a particular entity using data subsets associated with different synchronized identifiers, in accordance with at least an exemplary embodiment of the present disclosure.

### DETAILED DESCRIPTION

The present disclosure, in some embodiments thereof, relates to the industry ecosystems and, more particularly, but not exclusively, to a system for information processing, management and communications within an industry ecosystem.

Before explaining at least one embodiment in detail, it is to be understood that the disclosed system is not necessarily limited in its application to the details of construction and the arrangement of the subsystems and/or methods set forth in the following description and/or illustrated in the drawings and/or the Examples. The disclosed system is capable of other embodiments or of being practiced or carried out in various ways.

The platform described herein provides services, insights, and/or applications, amongst other things, for the purposes of facilitating workflows in an industry ecosystem including, but not limited to providing a holistic view into the relationships between varied industry participants and providing data exchange between them in an agnostic platform.

The term “synchronization” refers to a process that links distinct data records with a shared identifier or data structure. Synchronization of data is also referred to as “integration” of such data.

The term “synchronized identifier” refers to a unique alphanumeric, numeric, or other interpretable piece of data that uniquely corresponds to data records of a particular entity within a platform, and is associable with other synchronized identifiers within a knowledge graph to represent knowledge determined or otherwise identified as associated with the particular entity based on the data of the particular entity. In some embodiments, a synchronized identifier is associable with any number of third-party or external identifiers corresponding to one or more data records. In this regard, a synchronized identifier that is associated with any number of third-party identifiers may be linked with all data records corresponding to the third-party identifiers, for example via relationships formed with other data nodes linked to one or more other synchronized identifiers within the knowledge graph and associated with data for the same entity. The term “synchronized identifier” may also be referred to as a “ClarusID.”

The terms “centralized integrated data” and “synchronized data” refer to a data set that conveys knowledge associated with a particular entity and is formed from data records linked to one or more synchronized identifier for the particular entity, where the data set includes data from a knowledge graph that corresponds to data records from one or more different partner systems or is derived from data records from one or more different partner systems. A centralized integrated data set is derivable from a knowledge graph beginning at a particular node, for example a synchronized identifier represented as a node within the knowledge graph, for a particular entity.

The term “ecosystem” refers to an interconnected set of systems and entities interacting within a particular context, and data records identifying such entities, relationships, and actions between them.

The term “real-time” refers to a process occurring within a defined minimum compute time-frame. For example, in some contexts, a “real-time” system completes a computing task within a sub-one minute time frame.

The term “claims processing” refers to a data-driven computing process for receiving a claim related to a particular entity and performed service, determination of whether the claim sent or recommended to an originating system is to be approved or rejected, and providing notification regarding instructions or recommendations to transfer funds associated with the claim.

The term “plug-and-play” refers to a state of interacting with a particular system by an external system, where the external system is capable of communicating and otherwise interacting with the other system without specialized reconfiguring of the external system.

The term “federated” refers to data that is collaboratively generated, augmented, collected, or otherwise formed from a plurality of data sources.

The term “data gateway” refers to hardware, software, firmware, or the combination thereof, of a platform that stores and/or provides access to data records collected from any number of external sources. In some embodiments, a data gateway is configured to collect data in a federated manner, and/or maintain the data records as a knowledge graph.

The term “data interlink” refers to hardware, software, firmware, or any combination thereof, that maintains a logical separation of data accessible by a platform and/or utilized in services performed by the platform.

The term “agent” refers to an application that triggers and/or performs some or all of a software service or process automatically on behalf of a user.

The term “knowledge graph” refers to a data graph representation and/or a network diagram that links data records representing entities with actions, events, and other data associated with such entities. In one example context, a knowledge graph includes nodes for each entity and interconnections (e.g., edges) for actions, relationships, or other connections between the entities.

The term “temporal knowledge graph” refers to a knowledge graph that includes time-varying relationships between entities in the knowledge graph.

The term “relationship” refers to a data-derivable connection or association between two entities. Non-limiting examples of a relationship include a patient-practitioner relationship, an owner-pet relationship, an employer-employee relationship, and an insurer-insured relationship.

The term “data episodes” refers to a defined period of time or other contained sub-range of a temporal series of data records.

The term “normalized data container” refers to data that is converted to a standardized format, representation, or other structure.

The term “non-transitory computer-readable storage medium” refers to a permanent or tangible memory defined in hardware, software, firmware, and/or a combination thereof, that stores data and/or instructions.

The term “cloud” refers to any device, system, and/or the like that is remotely located from another system, and is accessible over at least one network.

The term “distributed data synchronization” refers to a process in which data associated with a shared entity is retrieved from distinct systems, which may represent the entity utilizing different identifiers, and ingesting such data associated with a shared synchronized identifier, where such data is stored in a knowledge graph based at least in part on the shared identifier.

The term “I/O circuitry” refers to input/output circuitry that is specially configured in hardware, software, firmware, and/or any combination thereof, to receive and/or process user input and/or provide audio, visual, and/or other output data to a user.

The term “identity management” refers to a process that generates an identity for a particular entity, synchronizes distinct identities as associated with a particular synchronized identity, and determines accuracy of identities and/or links between a synchronized identity and one or more data records.

The term “consent management” refers to a process in which an entity (e.g., a pet parent, a partner, and/or the like) configures access to and/or availability of data and/or information associated with the particular entity, a related entity, a relationship associated with the entity, or an event associated with the entity.

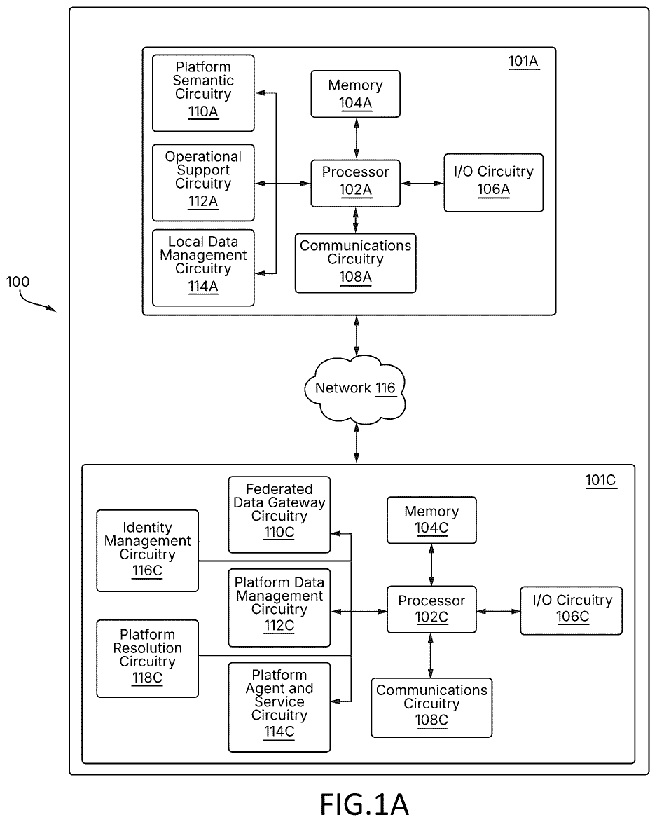

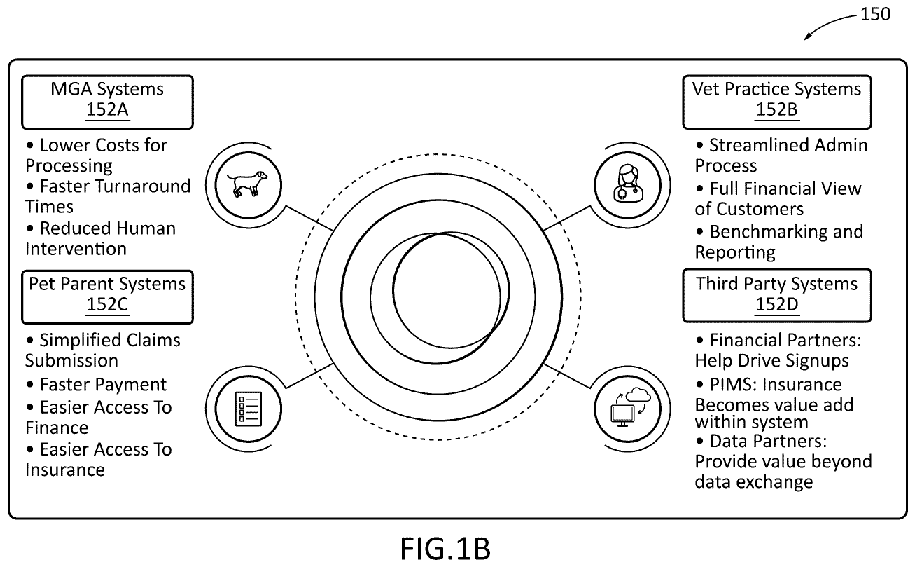

Referring now to the drawings, FIG. 1A is system architecture diagram of a real-time distributed data synchronization and access platform 100 (“platform 100”), for example embodying an animal health ecosystem platform, in accordance with an exemplary embodiment of the present disclosure. The platform 100 embodies the “Clarus platform,” specifically in which a system synchronizes and centralizes data between various external partner systems for use in the accurate and efficient provision of various data-driven services to the partners or other user (e.g., for efficient and accurate claims processing for claims related to pet insurance protections). In this regard, the Clarus platform embodied in platform 100 may be configured to perform any or all of the functionality described below. The platform 100 in some embodiments may be embodied by one or more computing systems, such as one or more of the partner apparatus 101A (“apparatus 101A”), and platform technology apparatus (“apparatus 101C”). It will be appreciated that, in some embodiments, the platform 100 may include any number of partner apparatuses and/or any number of identity provider apparatuses.

The apparatus 101A and apparatus 101C are configured to communicate with one another via the network 116. In some embodiments, the network 116 embodies or includes the Internet, and/or supporting hardware and/or software that facilitates communication via the Internet. Additionally or alternatively, in some embodiments, the network 116 includes one or more non-public communication networks.

As illustrated in FIG. 1A, the apparatus 101A includes a processor 102A, a memory 104A, input/output (“I/O”) circuitry 106A, communications circuitry 108A, platform semantic circuitry 110A, operational support circuitry 112A, and local data management circuitry 114. The apparatus 101A may be configured to execute some or all of the operations described herein with respect to the partner system herein. Although the circuitry 102A-114A are described with respect to functional limitations, it should be understood that the particular implementations necessarily include the use of particular hardware. It should also be understood that certain of these components 102A-114A may include similar or common hardware. For example, two modules may both leverage use of the same processor, network interface, storage medium, or the like, to perform their associated functions, such that the duplicate hardware is not required for each individually named circuitry.

The use of the term “circuitry” as used herein with respect to the components of the apparatus will be understood to include particular hardware configured to perform the functions associated with the particular module circuitry depicted and described. The term “circuitry” should be understood broadly to include hardware, software that configures the hardware, firmware that configures the hardware, and/or any combination thereof. For example, in some embodiments, “circuitry” may include processing circuitry, storage media, network interfaces, input and/or output devices, and the like. In some embodiments, other elements of the apparatus 101A may provide or supplement the functionality of particular circuitry. For example, in some embodiments, the processor 102A provides processing functionality, the memory 104A provides storage functionality, the communications circuitry 108A provides network interface functionality, and the like.

It should be appreciated that, in some embodiments, some or all of the circuitry may be associated with a separate device, server, and/or associated computing hardware, which may be in communication with one or more of the other circuitry components of the apparatus 101A. For example, in some embodiments, the platform semantic circuitry 110A, operational support circuitry 112A, and/or local data management circuitry 114A is included in and/or embodied by a separate computing apparatus. The separate computing apparatus in some embodiments may include a separate processor, memory, I/O circuitry, and/or communications circuitry.

In some embodiments, apparatus 101A and/or apparatus 101C are/is configured as a specially configured computer, or combination of computers arranged into a system. For example, in some embodiments, the apparatus 101A is embodied by or includes a mobile device, a laptop, a desktop, a smart device, a server, and/or the like. In some embodiments, the apparatus 101C is embodied by or includes a mobile device, a laptop, a desktop, a smart device, a server, and/or the like. The apparatus 101A and/or the apparatus 101C may be configured utilizing specially-configured instructions (e.g., an application) running on the device to execute the functionality discussed herein. For example, a mobile device embodying the apparatus 101A (or apparatus 101C) may be specially configured to execute instructions embodying a mobile application that, when executed by the mobile device, executes the functionality discussed herein. A desktop or laptop, in some contexts embodying the apparatus 101A (or apparatus 101C), may be specially configured to execute instructions embodying a native application or a web application that, when executed by the desktop or laptop, executes the functionality discussed herein.

In some embodiments, the processor 102A (and/or co-processors in some embodiments is in communication with the memory 104a via a bus for passing information among components of the apparatus 101A. The memory 104A may be non-transitory and in some embodiments includes one or more volatile and/or non-volatile memories. In other words, for example, the memory 104A in some embodiments is an electronic storage device (e.g., a computer-readable storage medium). The memory 104A in some embodiments is configured to store and/or provide access to data maintained by the apparatus 101A, for example to enable the apparatus 101A to carry out various functions utilizing such data as described herein.

The processor 102A may be embodied in any of a myriad of different ways. For example, in some embodiments, the processor 102A includes one or more processing devices and/or sub-processors configured to perform independently. Additionally or alternatively, in some embodiments the processor 102A may include one or more processors configured to operate in tandem via a bus, for example to enable independent execution of instructions, pipelining, and/or multithreading. The use of the terms “processing device,” “processor,” and/or “processing circuitry” may be understood to include a single core processor, a multi-core processor, multiple processors internal to the apparatus 101A, and/or one or more separate, remote, and/or “cloud” processors.

In some embodiments, the processor 102A is configured to execute computer-coded instructions stored in the memory 104A, or otherwise accessible to the processor 102A. Alternatively or additionally, the processor 102A in some embodiments is configured to execute hard-coded functionality. As such, whether configured by hardware or software, or by a combination of hardware with software, the processor 102A in some embodiments represents an entity (e.g., physically embodied in the circuitry) capable of performing operations in accordance with one or more embodiments of the present disclosure when configured accordingly. Alternatively, as another example, when the processor is embodied as an executor of software instructions, the computer-coded instructions in some embodiments specifically configure the processor to perform steps described here, for example embodying one or more algorithms and/or operations thereof.

In some embodiments, the apparatus 101A includes I/O circuitry 106A that may, in turn, be in communication with the processor 102A to provide output to the user associated with the apparatus 101A. Additionally or alternatively, in some embodiments, the I/O circuitry 106A is in communication with the processor 102A to receive input from a user. The I/O circuitry 106A in some embodiments comprises a user interface, for example a device display, web interface, mobile application, client device, and/or the like. Additionally or alternatively, in some embodiments, the I/O circuitry 106A includes one or more input devices, for example a keyboard, a mouse, a joystick, a touch screen, a microphone, and/or input/output mechanisms. The I/O circuitry 106A, alone or together with the processor 102A, in some embodiments controls one or more functions of the user interface, for example through executing computer-coded instructions stored on the memory 104A or otherwise accessible to the processor 102A (e.g., embodied in software and/or firmware). The communications circuitry 108A in embodied in hardware, or a combination of both hardware and software, that is configured for data receiving and/or data transmission, for example over a network. The communications circuitry 108A may transmit data from the apparatus 101A, and/or receive data at the apparatus 101A from another device, system, and/or the like. In some embodiments, the communications circuitry 108A includes at least one network card, at least one antenna, at least one switch, at least one router, at least one modem, at least one bus connecting components, and/or supporting hardware and/or software of any such components. In some embodiments, the communications circuitry 108A is a separate device that is configured to enable the apparatus 101A to perform such data receiving and data transmitting. For example, in some embodiments, the communications circuitry 108A is configured to interact with at least one antenna to facilitate signal transmission, and/or facilitate signal reception via the at least one antenna. In some embodiments, the apparatus 101A is configured to communicate via the communications circuitry 108A utilizing any communications protocol, or a combination of multiple communications protocol. Non-limiting examples of such communications protocols include Bluetooth Low Energy, infrared wireless communication, ultra-wideband communication, Wi-Fi, Near Field Communication, Worldwide Interoperability for Microwave Access, and/or the like.

In some embodiments, the platform semantic circuitry 110A includes hardware, software, and/or any combination thereof, that is specially configured to provide services specific to a particular partner computing environment and that interacts with one or more of the apparatus 101C. In some embodiments, the platform semantic circuitry 110A embodies or supports one or more “agents,” executed on a processor such as the processor 102A, that make a decision, execute one or more commands, and/or achieve a particular object or goal. In some embodiments, the platform semantic circuitry 110A is configured for enabling communication between the apparatus 101A and a platform technology subsystem, for example embodied by apparatus 101C as depicted and described further herein.

In some embodiments, the operational support circuitry 112A includes hardware, software, and/or any combination thereof, that is specially configured to provide partner-system level services. Non-limiting examples of such partner-system level services in some embodiments include one or more of support services, client communications services, and the like. In some embodiments, the operational support circuitry 112A is configured to provide some or all of such services without involving communication with the apparatus 101C.

In some embodiments, the local data management circuitry 114A includes hardware, software, and/or any combination thereof, that is specially configured to facilitate data storage and retrieval in a manner that is understandable by the apparatus 101A. It should be appreciated that different apparatuses 101A (corresponding to different partner systems, for example) may maintain data utilizing different services, data formats, schemas, and/or the like, such that each apparatus may maintain data in a different and specific manner usable by that apparatus. In this regard, the data stored by one apparatus 101A may not be readily interpretable and/or usable by another instance of the apparatus 101A. In some embodiments, the local data management circuitry 114A is embodied by or includes a database, or operates together with the memory 104A to provide data storage capabilities.

As illustrated in FIG. 1A, the platform 100 further includes the apparatus 101C. The apparatus 101C includes a processor 102C, a memory 104C, input/output (“I/O”) circuitry 106C, communications circuitry 108C, federated data gateway circuitry 110C, platform data management circuitry 112C, and platform agent and service circuitry 114C. The apparatus 101C may be configured to execute some or all of the operations described herein with respect to a platform technology system described herein. Although the circuitry 102C-114C are described with respect to functional limitations, As depicted, the apparatus 101C includes similarly-named circuitry to the apparatus 101A, specifically with respect to processor 102C, memory 104C, I/O circuitry 106C, and communications circuitry 108C. For brevity, repeated disclosure with respect to these components is omitted, as it should be understood that such similarly named components may provide the same or similar functionality with respect to operation of the apparatus 101C.

In some embodiments, the platform data management circuitry 112C includes hardware, software, firmware, and/or any combination thereof that generates and/or maintains a knowledge graph associated with one or more entities, events associated therewith, and/or the like. For example, in some embodiments, the platform data management circuitry 112C generates data records associated with a particular synchronized identifier or a plurality of synchronized identifiers (e.g., representing a particular entity), links data associated with different data records together (e.g., representing relationships, actions, events, or other connections between such entities), and/or otherwise pairs data processed by the platform. Additionally or alternatively, in some embodiments, the platform data management circuitry 112C maintains accuracy data associated with links between synchronized identifiers and/or connections between such data records.

In some embodiments, the federated data gateway circuitry 110C includes hardware, software, and/or any combination thereof, that provides data management and communication for the apparatus 101C. In some embodiments, the federated data gateway circuitry 110C embodies or includes a federated data intake system that enables data communication with one or more apparatuses 101A (e.g., each corresponding to a different partner system). Additionally or alternatively, in some embodiments, the federated data gateway circuitry 110C is configured to extract and provide certain data for a particular entity in a manner interpretable by a particular system (for example, embodied by apparatus 101A). In some embodiments, the federated memory gateway circuitry 110C is specially configured to perform data synchronization and integration, such that data from disparate data sources that are typically incompatible may be integrated, combined, and retrieved and/or processed jointly. In some embodiments, the federated data gateway circuitry 110C performs such data synchronization and integration utilizing one or more other components of the apparatus 101C, for example the platform agent and service circuitry 114C as discussed further herein.

In some embodiments, the platform data management circuitry 112C includes hardware, software, and/or any combination thereof, that stores synchronized and/or integrated data associated with any number of entities. In some embodiments, the platform data management circuitry 112C maintains the data associated with a particular entity, and received (and synchronized via the federated data gateway circuitry 110C) from one or more apparatuses 101A. In some embodiments, the platform data management circuitry 112C is embodied by or includes a database, or operates together with the memory 104C to provide data storage capabilities.

In some embodiments, the platform agent and service circuitry 114C includes hardware, software, firmware, and/or any combination thereof, that provides any number of platform-level agents and/or services. Each agent, or each service, in some embodiments is configured to perform a particular data-driven task, provide data insights, and/or otherwise process synchronized data made available via the apparatus 110C. In some embodiments, the federated data gateway circuitry 110C serves as a data interlink between such agents and/or services. It should be appreciated that the apparatus 101C may be configured to provide any agent or service that utilizes the synchronized data, including but without limitation simulation services and/or agents, automation agents, knowledge graph agents (including temporal knowledge graph agents), and/or the like. In some embodiments, the platform agent and service circuitry 114C generates and/or updates data of a knowledge graph, for example associated with a particular entity.

In some embodiments, the identity management circuitry 116C includes hardware, software, and/or any combination thereof, that is specially configured to maintain information associated with a particular entity. For example, in some embodiments the identity management circuitry 116C generates and/or otherwise maintains synchronized identifier(s) for particular data taken in that is associated with a particular entity, and/or for each of a plurality of entities. A synchronized identifier may be mapped to any number of third-party identifiers local to one or more external systems. In some embodiments, the identity management circuitry 116C embodies or includes one or more databases that store such data, or operates together with the memory 104C to provide such data storage capabilities. In some embodiments, the identity management circuitry 116C receives, intakes, and/or stores 2^{nd} party and/or 3^{rd} party attributes associated with a particular entity. In one example context, the identity management circuitry 116C is configured to maintain personally identifiable information associated with any number of entities.

In some embodiments, the platform resolution circuitry 118C includes hardware, software, and/or any combination thereof, that performs data synchronization and/or resolution of data from one or more external systems. For example, in some embodiments, the platform resolution circuitry 118C receives, stores, maintains, and/or integrates data associated with a particular entity, where such data is received from one or more external systems. Additionally or alternatively, in some embodiments, the platform resolution circuitry 118C is configured to provide data enrichment of received data. For example, in some embodiments the platform resolution circuitry 118c is configured to perform mapping of received data to pseudonym data (e.g., mapping personally identifiable information to pseudonym identifiers and/or other household or provider-specific pseudonym identifiers), a particular synchronized identifier, and/or the like.

FIG. 1B is an illustration showing high level concepts touched by an animal health ecosystem platform 150 (“platform 150”), in accordance with an exemplary embodiment of the present disclosure. The platform 150 in some embodiments embodies or is configured in accordance with the platform 100. In an embodiment, the animal health ecosystem platform is an open participation platform that facilitates industry data exchange. The platform provides services, insights, and/or applications at a detailed sub-data level (e.g., a pet level), as desired by a particular partner system, with additional services (e.g., financial services, care providers, products and services suppliers, and/or the like) to serve data owners, processors, and/or controllers and/or controllers (e.g., the pet parents/owners) with related dynamic, real-time, and/or synchronized data services between partners and/or other participants accessing the platform, and/or to serve full lifecycle support for insurance services including underwriting, policy product development, claims processing and care plans/wellness administration, financial services including payments and/or financing, financial services including payments and/or financing, industry research, lead generation, analytics, data insights, and/or product development, and/or consumer services including appointment scheduling, subscription services, and is technically capable of facilitating the ordering and/or delivery of products, including dog food, pet supplies, treats, toys, vitamins/supplements, prescriptions, and the like.

The platform 150 provides various improvements to different systems. For example, with respect to MGA systems 152A, some embodiments of the present disclosure provide such systems lower costs for processing, faster turnaround times, and reduced human intervention (e.g., increasing accuracy of quicker data processing tasks for a lower cost). With respect to vet practice systems 152B, some embodiments of the present disclosure provide for streamlined admin processes, financial view of customers, and benchmarking and reporting capabilities. With respect to pet parent systems 152C, some embodiments of the present disclosure provide for simplified claims submission, faster payment processes, easier access to financing and related information, and easier access to insurance and related information (e.g., all in one platform). With respect to third party systems 152D, some embodiments of the present disclosure provide for advantages to different classifications of partners (e.g., facilitating signups to financial partners, driving insurance as a value add for PIMS partners, and driving value insights beyond data exchange for data partners

In some embodiments, the platform 150 includes various sub-systems that each communicate with a data synchronization and access system 170 (the “system 170”). In some embodiments, the data synchronization and access system 170 is embodied by the apparatus 101C as depicted and described in FIG. 1A. The system 170 in one example context is the “Clarus system” that provides data synchronization and access across multiple partner systems, enables services based on centralized integrated data from one or more partner systems, and the like. In one example context, the Clarus system 170 is an animal healthcare and data management system.

It should be understood that the sub-systems of the platform 150 in FIG. 1B, such as MGA systems 152A, vet practice systems 152B, pet parent systems 152C, and third party systems 152D, are “Partners”, are by way of example only, and should not be construed as limiting, for example, all of these could be considered as participants in the animal health industry ecosystem, as well as many others/categories which are not shown as they would be unnecessarily cumulative, but are known to those in the industry. In this regard, each partner entity may utilize a system to access the platform and communicate with a centralized system (e.g., the “Clarus” system embodied by the apparatus 101C configured to perform the distributed data synchronization and access functionality discussed herein) for any of a myriad of services available to and/or specific to that partner. Such systems may communicate with the centralized system via a software application, web application, and/or other instructions executed on the corresponding partner's system (e.g., a web application accessed via a mobile device of a pet parent embodying a pet parent system 152C, for example). Non-limiting examples of such services are depicted and described in FIG. 1B. Additionally, it will be understood that the animal health industry—and particular the pet-focused animal health ecosystem and platform described as an ongoing example throughout this application—is an illustrative example, and that the technical details and advantages provided by the platform herein may be similarly applied and utilized in other industries, sectors, use cases, and the like.

An animal health ecosystem platform may be comprised of various sub-systems, implemented in hardware, software, firmware, and/or a combination thereof. Additionally or alternatively, in some embodiments, the platform is connected to or otherwise communicable with one or more external systems.

Partner systems are embodied by the devices, systems, platforms, networks, and the like, that are configured to provide functionality for individuals and/or entities that participate in any capacity in the use of the platform. Examples of entities that interact with Partner systems include the following:
a) Pet Owners/Parents.
b) Financial Services partners—categories can include insurance, payments, aggregators and/or financing. Exemplary use cases—Facilitation of payments at the point of care, processing of insurance claims, providing financing options.
c) Ecosystems/Platform provider partners facilitators that connect pet parents with a suite of products/services including use cases such as: find a veterinarian, find a specialist, and/or find me the right insurance product. Additional derived applications can include, as examples, pet parent and partner level consent management. With respect to consent management, each Partner's consent preferences (e.g. with respect to what information, how much, and/or with whom) can be saved at a record level and/or at a transaction level, for example at the Partner subsystem and/or platform technology subsystem. Ecosystem/Platform provider partners utilize systems that are specially configured to perform appropriate data integration, synchronization, translation, access authentication, and the like to ensure that disparate and/or distributed partner systems associated with various partners are configured to integrate via a shared platform that is accessible by individual entities and/or partners (e.g., pet parents/owners) and associated service provider partners (e.g., veterinarians, pet goods sales companies, and the like).
d) Care Providers partners—categories can include veterinary practices, emergency hospitals, specialists, groomers, boarders, pet walkers and/or could potentially include pharmacies. Exemplary use cases include medical record sharing and appointment scheduling.
e) Animal Health Industry Organization partners.

In some embodiments, each partner system has, or is configured for secure authenticated communication with, one or more of platform semantic agents are installed inside, or otherwise provide services for, the partner's computing environment. The platform semantic agents manage data modeling, access and/or performance. In some embodiments of the disclosure, at least one “agent” is a software program (or hardware programmed by a software program) that can make a decision and execute a command related to at least one subsystem of the platform to achieve an object or goal. Agents can be static, following rules, or the agent can be adaptive, for example making decisions, optionally based on rules but employing generative AI (e.g., AI-powered ETL) to modify, adapt and/or effectuate those decisions. Additionally, in some embodiments it normalizes personally identifiable information (PII) in combination with the identity provider subsystem to a practice web UI module and provides, among other things, transparency into partner workflows, pet health location-based insights, pseudonymous or anonymized ID (e.g. to maintain patient/owner confidentiality) and maps partner definitions to platform technology subsystem standards for use by the platform technology subsystem and other subsystems of the platform. In some embodiment of the disclosure, each partner system of the partners includes at least one of a customer experience module (including such functionality as customer support, applications like web, mobile; communications like email, SMS and other forms of interaction with customers), an operations systems module, a data storage (including such functionality as database activities for both real time and historical access to collected, transformed or derived information), and a customer relationship management module (including such functionality as systems for marketing, sales and activities related to sourcing and managing the relationships with customers). Such subsystems may provide support for functionality specific to each partner system, for example such that different partners are enabled to individually provide and customize services for users.

In an embodiment, the platform technology subsystem represents a central information/data processing, management, access control and/or analytics functionality for the platform. Communications with the platform technology subsystem are conducted through a federated data gateway, in some embodiments. Amongst other tasks, the federated data gateway uses a query schema that maintains data in its canonical location, along with access control. Canonically, in some contexts, each partner maintains their own source of truth in source data, using their respective definition, maintenance and governance of the data entities that are relevant to their business. In other words, a partner system may collect and maintain its own data separate from the Clarus platform as described herein, and may nevertheless access the Clarus platform to provide such data, build and/or enhance a knowledge graph accordingly, and/or utilize one or more business services that leverage the knowledge graph associated with such a knowledge graph without altering the data stored on the partner system itself (and which the partner system may trust as accurate).

The federated data gateway also provides a data interlink between at least one of an automation agent, medical record AI agent, a temporal knowledge graph agent and the partner web UI module, in some embodiments of the disclosure. In some embodiments of the disclosure, the data interlink maintains logical separation of data for data provenance tracking and/or processing and/or verification purposes. Additionally, alternatively and/or optionally to the above, the platform technology subsystem provides and/or performs other information/data related processes including one, some or all of normalization agent, workflow logic agent, simulator and admin configuration agent, summarization and inference agent, treatment and condition coding agent, pet health taxonomy agent, health history agent, workflow history agent, relationship links agent, and workflow analytics, medical analytics and partner analytics. In this regard, such integration enables disparate and typically incompatible data types, which may be of the same data format and distinct standardization and/or of entirely distinct data formats, to be integrated, combined, processed, and/or the like in a manner that independent systems fail to enable. The specific configuration of the federated data gateway, together with its linkage to one or more of the automation agent, medical record AI agent, a temporal knowledge graph agent and the partner web UI module, provide these advantages and/or further advantageously enable other provider systems to utilize such integrated systems. In some embodiments, the temporal knowledge graph comprises one or more synchronized identifiers that correspond to one or more subsets of data associated with an entity. The agent may identify respective subsets of data that are associated with one another, and link the one or more synchronized identifiers associated with such subsets using a relationship within the knowledge graph. In this regard, as the temporal knowledge graph is built based on various data from any number of distinct partner systems, complex knowledge determinations (e.g., insights determinable from data values, interactions between data values, and/or the like) and/or other services may be provided.

In an embodiment, at least one automation agent is used to process data from at least one partner system of the Partners, according to the relevant workflow logic agent. The workflow logic agent orchestrates automation relevant to the partner's workflow by managing sequencing and inter-agent communication. The workflow logic agent uses dynamic task sequencing to determine the order and conditions under which tasks are executed, adapting the flow based on real-time data, agent outputs, or external events. For example, it may decide whether real-time information should be used to route a claim for automatic approval, further assessment, or human review. The workflow logic agent in some embodiments uses reasoning modules (often, for example, powered by large language models (LLMs) or rule-based engines) to plan the next steps, decompose complex tasks into subtasks, and select the appropriate agents or tools for each step. As part of orchestration, the agent maintains workflow state and context, ensuring that all other computing agents have access to relevant information and prior decisions throughout the automation. Additionally, the workflow agent maintains audit trails and publishes updates for any subscribers.

A normalization agent transforms disparate data formats into a consistent schema, ensuring that downstream agents receive uniform structured and/or harmonized input to enable cross-platform data integration and processing (e.g., whereas other implementations with disparate systems would fail to be usable in a manner that combines the relevant data from each individual subsystem), improve automation reliability, and regulatory compliance. For example, in some embodiments such normalization includes a specially configured application programming interface that codifies data to be received in a defined manner of key-value pairs. The key-value pairs may be configured in a manner that is agnostic to the content of the data received from a partner system, and is processable so long as the key-value pairing provided from the platform is maintained. Additionally, it removes duplicates, enforces data integrity, and strips sensitive or extraneous information. Normalization is performed using a sequence of pattern matching, machine learning algorithms and categorical mappings.

A simulation and configuration agent, continuously tests and refines the configurations and workflows of all other automation agents. The Simulation and Configuration agent runs large-scale, realistic simulations of one or more provider services that utilize available data, for example data of a particular provider system or the integrated (e.g., combined and normalized) data of multiple provider systems in the manner discussed herein. In this regard, the Simulation and Configuration agent, by leveraging the integrated data formed via the Platform Technology subsystem, is configured to provide simulations with greater accuracy due to the improved accuracy and/or robustness of data available upon integration. In one example context, the Simulation and Configuration agent runs such simulations for the entire claims process, modeling interactions between all agents and external partners (veterinary practices, insurers, financiers). During simulation, it identifies bottlenecks, failure points, and inefficiencies by observing emergent behaviors and outcomes in the simulated environment using historical data. For configuration, it applies optimization algorithms (e.g., particle swarm optimization) to recommend new configurations, workflow sequences, and/or policy rules that improve computing/processing speed, accuracy, and/or cost-effectiveness.

In the example of claims processing, this workflow agent applies the logic of an insurance policy against invoice data (derived from, amongst other things, treatment and condition coding agent). Configuration of relevant gates and rules in this workflow, is done through the simulation agent that reads historical behavior from the federated data gateway. Payment as a result of a processed claim, optionally payment by a third party, may be handled by another separate workflow agent.

In an embodiment, the medical record AI agents module uses the summarization and inference agent to identify incidents from medical records. This summarization and inference agent learns from specific partner nuances as medical records are generally unstructured, free form medical notes. These incidents are then automatically used by the treatment and condition coding agent to correlate such incidents with corresponding data from one or more other records and/or of one or more other data types. For example, the incidents may be used to correlate with invoice line items by incident, according to diagnoses, treatments and/or conditions. In some embodiments of the disclosure, the inferring includes formulating a supposed “reason for visit” and appurtenant conditions. Additionally, it allows for proper incident assignment and/or diagnosis information to the right insurance policy. In some embodiments, there is a future predicative condition functionality as well. In some embodiments, a medical history summarization is prepared using the medical record AI module. The pet health taxonomy Agent continuously organizes, classifies and/or maps data to be used by the other medical record agents. This includes standardizations of medical terms, disease and treatment categorization, and interoperability by translating various data formats and terminology into a common schema. For example, different data formats may be standardized or otherwise normalized into a codified set of key-value pairs of data, which are then processed for storage by the Clarus platform (e.g., in a knowledge graph) utilizing any of a number of algorithms, AI/ML agents, and/or the like as discussed herein. In some embodiments, such standardization is content agnostic, such that so long as the provided data fits the codified schema (e.g., key-value pairings for certain data), it may be successfully ingested by the platform. In this regard, the data output by the medical record AI module may be in a standardized format that provides data values derived from any number of a plurality of disparate data sources (e.g., disparate provider systems) despite such individual provider systems maintaining independent data records, data formats, storage mechanisms and/or platforms, and/or the like.

In an embodiment, the temporal knowledge graph agents maintain time varying relationships adjacent to a pet, ranging from details such as breed to specific incident details, pet relationships to Partners, and relevant data about the pet from and/or stored by one or more of the partner systems associated with those Partners. The temporal layer allows for the system to reconstruct the state of knowledge at any point time, especially important when determining insurance claim eligibility. The health history agent collects, organizes, and updates longitudinal (e.g., across time) health data for each entity (e.g., a pet), such as diagnoses, treatments, outcomes, and time-stamped clinical events. The health history agent encodes this information as nodes (e.g., “diagnosis: diabetes”) and temporal edges (e.g., “treated with insulin on 2024 Mar. 01”) in the knowledge graph, preserving the sequence and timing of medical events. It should be appreciated, as described herein, that the temporal knowledge graph agents may generate, update, and/or otherwise maintain a temporal knowledge graph based on a combination of various data points and/or data records, for example individual data records from one or more provider systems, individual data records or values from multiple provider systems (e.g., and integrated utilizing the platform technology subsystem as described herein), and/or combined data records or values integrated based on data from multiple provider systems (e.g., utilizing the platform technology subsystem). In this regard, the temporal knowledge graph agents may be configured to dynamically create, delete, update, and/or otherwise represent data values and/or data records in the centralized integrated data (e.g., formed from individual data points and/or data records from any number of disparate, distributed Partner systems), such that the temporal knowledge graph formed is of improved accuracy by accounting for the disparate data points of multiple independent provider systems and/or accounting for the relationships that are derivable from integrated data formed from a combination of data of a plurality of independent provider systems. It should be appreciated that the temporal knowledge graph agents (or in some embodiments, one or more other agents associated with graph construction and/or maintenance) may additionally maintain static data and/or relationships, for example where such data values and/or relationships do not change status over time.

The workflow history agent tracks a log and/or status of one or more events in the workflow logic agent, for example throughout the progression of an episode in the workflow logic agent. In the example of an insurance claim, this includes which individual entities handled it, what actions were taken and when. Example events, such as “claim submitted,” “assessment completed,” “financing offered”) as nodes and edges, each with associated timestamps, creating a process-level timeline linked to the health history.

The relationship links agent identifies and manages relationships in an integrated data graph, for example a knowledge graph and/or temporal knowledge graph discussed herein, including for example the relationships between entities (e.g., pet-owner, vet-practice, insurer, financing partner) and between events (e.g., “claim X is related to treatment Y”). The relationship links agent maintains and updates edges that represent these relationships, including their temporal validity (i.e., when the relationship started, changed, or ended). In this regard, the relationship links agent may be configured to dynamically create, delete, update, and/or otherwise represent relationships identified between entities and between events for one or more nodes in a graph based on the integrated data of any number of provider systems, such that the temporal knowledge graph (for example) formed is of improved accuracy by accounting for the disparate data points of multiple independent provider systems and/or accounting for the relationships that are derivable from integrated data formed from a combination of data of a plurality of independent provider systems.

In an embodiment, the practice web UI module provides transparency into partner workflows, pet health and location-based insights. Generally, workflow analytics generates reports on the specific inputs of each workflow decision point and relevant output. Workflow analytics, combined with temporal graph, facilitate uses cases that range from detailed auditing to predictive modelling. Medical analytics generates reports on condition trends, and partner analytics generates reports on transparency in the market and on trends specific to practice administration.

In some embodiments, the Identity Provider Subsystem receives, stores, maintains, and/or integrates identification information (e.g., personally identifiable information (PII) associated with an entity (e.g., individual, provider, participant, and/or the like) for one or more provider systems. The identity provider subsystem in some embodiments includes Identity Enrichment, in some embodiments. The identity enrichment securely maps PII to pseudonymous IDs and other household (or the like) pseudonymous IDs. Additionally, 2nd or 3^{rd} party attributes are included for additional information, demographics and/or psychographics, in some embodiments.

It should be noted that because a plurality of different partners utilize the platform, representing different types of animal health ecosystem providers/participants, most with different data formats and data systems, standardization of data for use within the platform is performed on data coming from and/or going to Partners centrally at the platform technology subsystem rather than at each, or exclusively at each, Partner locally and/or at the edge, by the platform semantic agents. For example, in some embodiments, the integrated data is generated and/or stored centrally as described herein via the platform technology subsystem. Such data is transformed and/or otherwise processed for specific processing by and/or transmission to a particular provider system, which may use a particular data format and/or data system. It should be appreciated that as described herein, different provider systems may utilize different data formats and/or data systems, such that the same integrated data maintained via the platform technology subsystem may be transformed differently for processing and/or transmission to the different Partner systems. In some embodiments, partner systems are associated with a particular format that is utilized by the platform for providing data insights and/or knowledge derived based on queries from that partner system. The integrated data may be centralized integrated data, such that the data is maintained via the platform technology subsystem, and may be maintained separately from independent sources of data stored at each Partner system (e.g., of the Partners). Advantageously over other systems that fail to provide such integration and individualized data distribution, the improved transformation enables each of the Partner systems to further individually utilize the available data without concern for the data format and/or data systems utilized by the other Partner systems and/or the platform technology subsystem itself. In some embodiments, the data is normalized before being transmitted between subsystems within the platform. For example, normalization is performed in the platform semantic container.

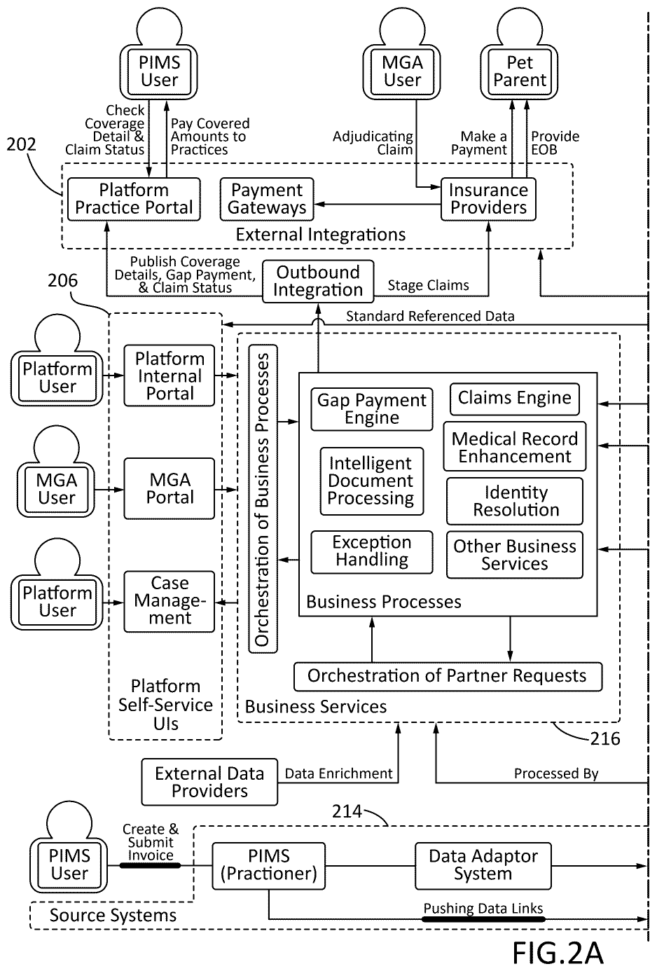

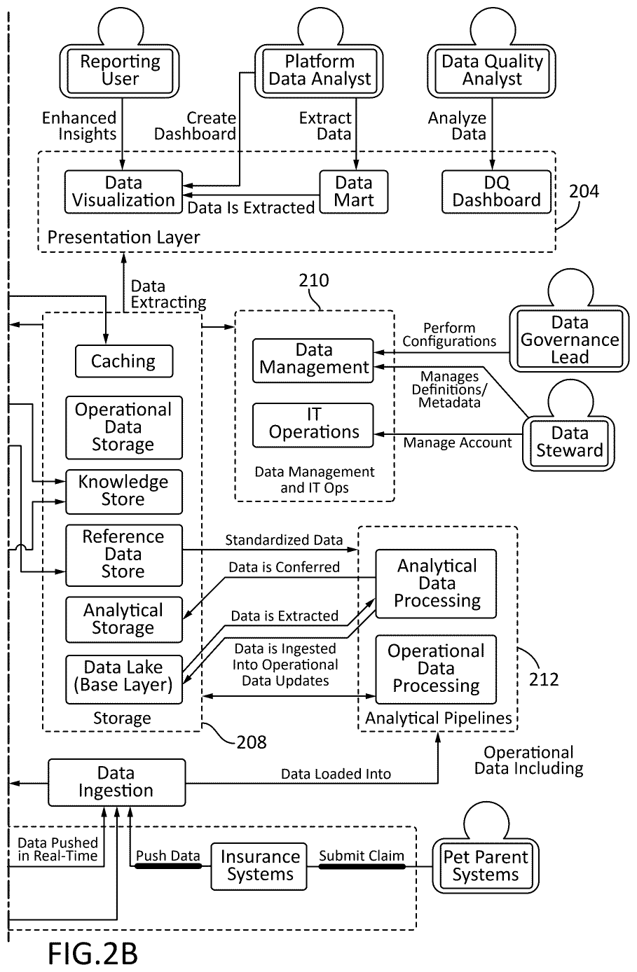

FIGS. 2A-2B depict a block diagram of a real-time distributed data synchronization and access platform, for example embodying an animal health ecosystem platform, in accordance with an exemplary embodiment of the present disclosure. Specifically, FIGS. 2A-2B depict an example real-time distributed data synchronization and access platform 200 (“platform 200”). In some contexts, the platform 200 embodies an animal health management platform for various interacting systems.

The platform 200 includes various source sub-systems 214, for example including a PIMS and data adapter system. In some embodiments, a PIMS user creates and submits an invoice via the PIMS, and the data adapter system retrieves such data and pushes the data in real-time for processing and/or storage via the rest of the platform 200 (e.g., via data ingestion). Additionally or alternatively, in some embodiments, one or more data links are directly pushed to the rest of the platform 200 by the PIMS, for example without the data adapter system. Additionally or alternatively, in some embodiments the source sub-systems 214 includes one or more insurance systems. In some embodiments, a user (e.g., a pet parent) utilizes a user system (e.g., a pet parent system) to submit a claim to the insurance system, where such data is then pushed to the rest of the platform 200 (e.g., after data ingestion) as depicted and discussed herein.

In some embodiments, data ingestion includes loading raw data into one or more analytical pipelines 212. The analytical pipelines may be supported by AI agents, manual processes, and/or any combination of automatic software driven processes and/or user-driven processes. In some embodiments, the analytical pipelines 212 include an analytical data processing pipeline and an operational data processing pipeline. The operational data processing pipeline in some embodiment loads and/or updates operational data into the storage 208, for example into a persistent and/or non-volatile data storage (e.g., a data lake). Additionally or alternatively, in some embodiments, the analytical data processing pipeline loads analytical data from the persistent and/or non-volatile data storage, and/or pushes analytical data into an analytical storage of the storage 208. In some embodiments, one or more of the analytical pipelines 212 are performed based at least in part on reference data stored to a reference data store of the storage 208.

In some embodiments, the platform 200 supports data management & IT ops processes. In some embodiments, the data management & IT ops 210 are supported by data stored to the storage 208. For example, in some embodiments, the IT operations include management of accounts by a data steward, and the data management operations includes a data steward that performs data management (definition, metadata management, and/or the like) of data stored to the storage 208, and/or a data governance lead that configures the storage 208 and/or data therein.

In some embodiments, the platform 200 includes one or more storage systems 208. For example, in some embodiments the platform 200 includes caching systems, operational data storage systems, knowledge store systems, reference data store systems, analytical storage systems, and persistent and/or non-volatile data storage systems. Each of such systems may be specially configured to ingest, maintain, and/or store particular data, for example. Additionally or alternatively, in some embodiments the platform 200 includes one or more external data providers that provide enrichment data for other data included in and/or maintained by the platform 200. In this regard, third-party data from one or more Partners may be ingested and used as an enhancer and/or resolution of other data available to the platform 200, for example by being utilized to disambiguate or further complete one or more data records received from a partner system. In some embodiments, the platform is specially configured to perform data triangulation based on the nexus of available data in a knowledge graph associated with one or more entities to resolve ambiguity with respect to additional and/or new data records for one or more entities.

In some embodiments, the platform 200 is specially configured to support any number of business services. For example, in some embodiments, the platform supports business services 216. In some embodiments, the business services 216 include a gap payment engine (e.g., for processing gap payments), an intelligent document processing system (e.g., for ingesting and/or otherwise processing documents based on available data), an exception handling service, a medical record enhancement service, a claims engine (e.g., for claims processing), an identity resolution service (e.g., for synchronizing distinct identifiers associated with the same entity to a single, shared or synchronized identifier), and/or one or more other business services. Additionally or alternatively, in some embodiments, the business services include orchestration of one or more of such business processes or other business processes.

In some embodiments, the platform 200 provides access to one or more platform self-service UIs 206, In some embodiments, such UIs 206 include a case management UI, an MGA portal, and a platform internal portal. In some embodiments, one or more distinct UIs are utilized by distinct users associated with the particular purpose. For example, in some embodiments a platform user accesses the case management UI to access particular case management business processes associated with that user and/or their data. Additionally or alternatively, an MGA user may access an MGA portal to utilize MGA-related business services (e.g., for claims processing). A different platform user may access the platform internal portal to access particular business services associated with the platform.

In some embodiments, the platform 200 is configured to enable one or more outbound integrations. For example, in some embodiments, the platform 200 supports one or more external integrations 202. In some embodiments, the platform 200 supports a platform practice portal, for example where a practice (e.g., a veterinarian practice) accesses platform services and/or data specific to their practice. Additionally or alternatively, in some embodiments, the platform 200 supports insurance providers and/or payment gateways associated therewith. For example, the platform 200 in some embodiments provides outbound integrations to insurance provider systems for adjudicating claims, making a payment, providing pet parent's EOBs, and/or the like. Additionally or alternatively, in some embodiments, the platform 200 supports payment gateways for performing payment of covered amounts, gap payments, and/or the like. It should be appreciated that one or more of the services may be specially configured to provide such services utilizing at least one specially configured AI agent.

In some embodiments, the platform 200 includes a presentation layer 204. The presentation layer supports various dashboards and/or data access UIs. For example, in some embodiments, the presentation layer 204 includes data extraction that is then output to a dashboard (e.g., specially configured UI) for a particular user and use case. For example, in some embodiments, a quality analyst accesses a data quality (DQ) dashboard to analyze data stored to the storage 208. Additionally or alternatively, in some embodiments, a platform data analyst in some embodiments accesses a data mart to perform data extraction of particular data in the storage 208. The platform data analyst in some embodiments creates particular dashboards for other users, for example to report to a reporting user. In some embodiments, a reporting user accesses a data visualization (e.g., a created dashboard) to receive enhanced insights associated with the data stored to the storage 208 in the platform 200.

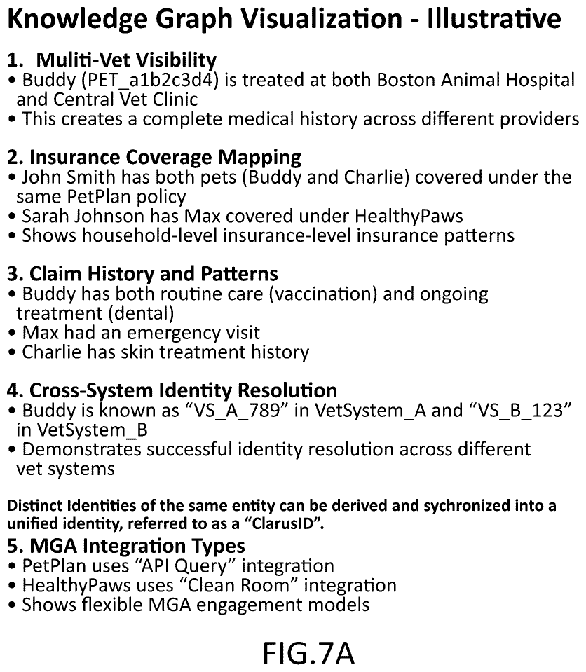

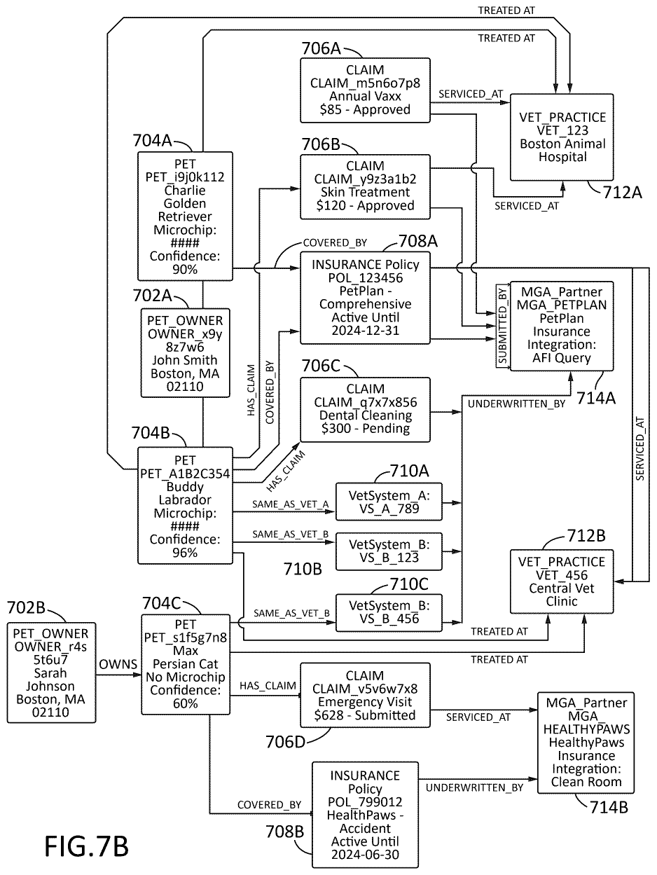

In some embodiments, the platform 200 is specially configured to create a synchronized knowledge graph representing and/or derived from data loaded to the platform 200. For example, in some embodiments, the synchronized knowledge graph links data records and/or nodes associated with a particular entity with other nodes representing related entities, relationships between entities, actions performed by or associated with such entities, and/or the like. An example knowledge graph is depicted and described herein with respect to FIGS. 7A and 7B.

Additionally or alternatively, in some embodiments, the platform 200 generates and/or utilizes one or more synchronized identifiers for a particular entity to link various data records to the entity. The synchronized identifier may be a universal identifier linked to one or more data records associated with the entity, and that is agnostic to one or more other identifiers that may be utilized to represent the entity in other systems, including one or more other third-party systems. The synchronized identifier (called a “ClarusID” for the Clarus system, for example) may be universal, persistent, and uniquely identify each pet, owner, pet parent, caregiver, veterinarian practice, and/or the like, and/or its surrounding ecosystem, for example a pet's home, medical history, insurance relationships, events, and/or other attributes connected to an entity. The synchronized identifier provides a persistent internal identity that is not reliant on, or otherwise decoupled from, other systems external to the platform, and enables consistent recognition of the same entity across all relevant data sources, stakeholders, and services. As data is ingested and processed, a knowledge graph may be built of nodes linking the data insights from ingested data records to a particular synchronized identifier. Various synchronized identifiers determined to be associated with the same entity, or otherwise in a relationship with a particular entity, may be linked to form a sub-graph of data associated with the particular entity. Such a knowledge graph allows for graph-based traversal of the knowledge represented by the various data nodes in the graph and relationships therebetween, which may continue to be updated by linking particular synchronized identifiers and/or may be read by querying then knowledge graph based on one or more of the synchronized identifiers that are linked together to form a more complete knowledge graph for a particular entity or various entities. Additionally, such stability allows the implementation of the platform to remain future-proofed regardless of data sources and/or connections, and allows for seamless data consolidation amongst such external systems, and/or as such external systems change.

In some embodiments, a synchronized identifier is mapped or otherwise integrated with a physical or technical real-world element, for example a pet's tag or chip, or another RFID element. In some embodiments, such a real-world linked element ensures certainty when identifying a pet to store and/or retrieve data associated therewith. This provides certainty in both the platform itself and its uses in data storage and analysis for end users interacting with a pet or other entity.

In some embodiments, the nodes represented in the knowledge graph embody data insights that correspond to one or more synchronized identities of entities represented therein, and connections between the nodes represent relationships and/or events between such entities. In this regard, the knowledge graph may codify such relationships and events, for example treatments, claims, previous addresses, ownership changes, and/or the like to create a living and temporal mapping of data associated with the entity. For example, as discussed further herein, nodes within the knowledge graph may include data values and/or insights associated with a particular entity, event, and/or the like, and edges may connect the nodes to a ClarusID and/or define a relationship to other data values, insights, and/or the like represented in other data nodes within the knowledge graph. The mapping of such data in the knowledge graph allows for analysis of such data in an advanced and accurate way, supports accurate claims adjudication (including time-based considerations), enhances fraud detection, and provides unified visibility into data associated with each entity.

It should be appreciated that a synchronized identifier may be linked with a particular entity, and the accuracy of such determinations or decisions may be updated over time. For example, in some embodiments, a synchronized identifier may be associated with a particular entity, and data linked to that entity. Third-party data, from any of a number of partner systems or other data sources, may be ingested by the platform 200 and stored associated with the synchronized identifier for such an entity. In a circumstance where the platform 200 processes subsequent data, an accuracy of such a linkage to the synchronized identifier may be updated (e.g., serving as a probabilistic match). In a circumstance where an accuracy is deemed inaccurate (e.g., falls below a certain threshold), the link may be severed and such data records may be assigned to a different synchronized identifier (e.g., having a higher accuracy) or a new synchronized identifier.

The platform 200 utilizes the various data records and entity representations to provide a holistic view of data and services to various third-parties and users. The ecosystem provides services that connect veterinary practices, for example, to ensure companies that provide pet services can utilize centralized, integrated data for accurate claims submission, resolution, and payments. Additionally, the platform 200 further supports the pet parent through processes that rely on the pet's associated data and/or insights therefrom.

To achieve this successfully, such implementations involves a systemic approach to developing the technology, data assets, consent, and product value proposition to the broader marketplace. Additionally, the Clarus system prioritizes data quality and governance to support this and position Clarus and its stakeholders for commercial viability.

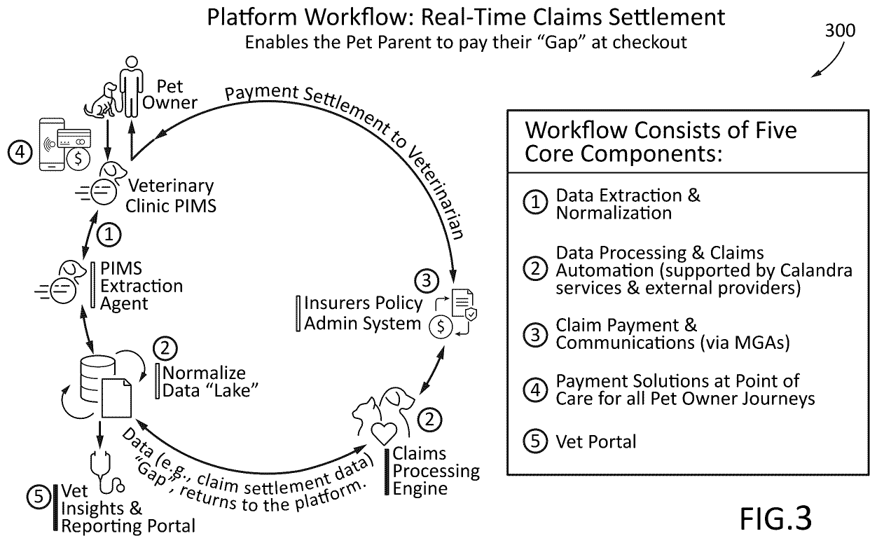

FIG. 3 is a workflow diagram of a real-time claims settlement process 300, in accordance with an exemplary embodiment of the present disclosure. In an embodiment, it is conceived that the exemplary workflow shown in FIG. 3 allows a pet parent/owner to pay a difference between the costs for treatment and what is covered by insurance, the “gap” for which a “gap payment” is made, at the time of service and while at the medical service provider (e.g. veterinary clinic). The process 300 commences with the presentation of the patient (pet) at the clinic at step 1 and proceeds in a counter-clockwise fashion around to the pet owner paying the gap at Step 4, and then subsequently insights/analytics and/or reporting in Step 5 is achievable based on the data accumulated by the current patient visit and/or previous patient visits and/or other patients' visits.

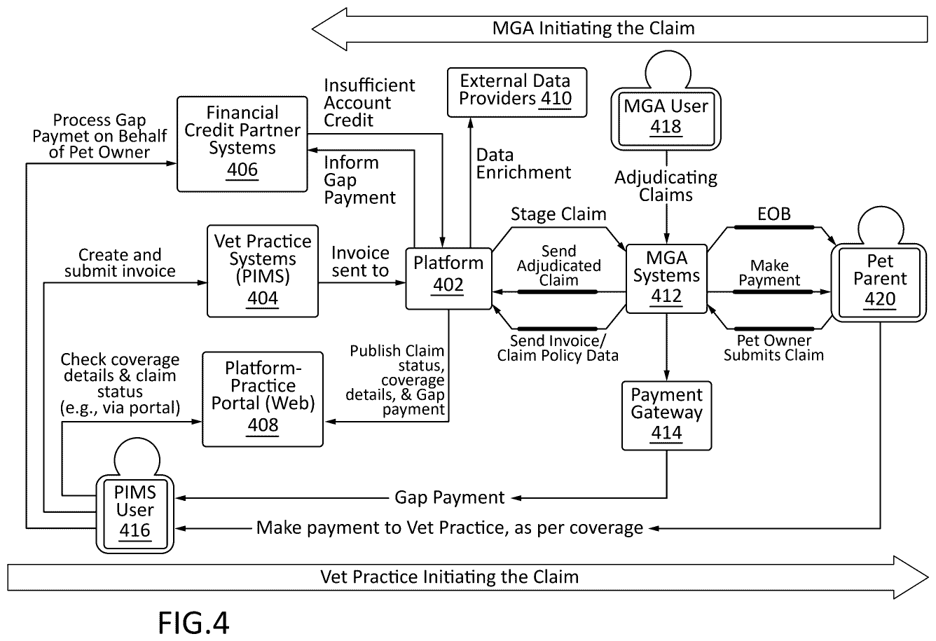

FIG. 4 is a hybrid block diagram and flowchart showing a real-time claims settlement process, in accordance with an exemplary embodiment of the present disclosure. FIG. 4 shows various subsystems associated with a platform 402, including credit partner systems 406, vet practice systems 404 (e.g., PIMS for one or more veterinarian practices), MGA system 412, and a payment gateway 414. In some embodiments, the platform is accessible to a user (e.g., a PIMS user 416 associated with a particular practice) via a platform-practice portal 408. The platform-practice portal 408 may be embodied by a web portal accessible online, via an application, and/or the like. In one example context, a PIMS user 416 creates and submits an invoice via a vet practice system of the vet practice systems 404, and such an invoice is sent to the platform 402. Additionally or alternatively, a pet parent 420 (e.g., an owner) may submit a claim to at least one MGA system of the MGA systems 412, and/or may receive an explanation of benefits (EOB) and/or make a payment regarding coverage provided by or associated with the MGA system. The claim submitted by the pet parent 420 may be regarding services performed for a particular pet, for which a payment is owed to a particular vet practice for example. The platform 402 is utilized for data enrichment via one or more external data providers 410, and form a knowledge graph, and in some embodiments a synchronized identifier associated with a user, based on the various data associated with that entity. The platform 402 in some embodiments stages a claim with at least one of the MGA systems 412, and an MGA user 418 adjudicates the claim(s) via the MGA system. The MGA system 412 in some embodiments sends adjudicated claim to the platform 402, and/or sends invoice and/or claim policy data to the platform 402. The platform 402 may inform a credit partner system of the credit partner systems 406 of a gap payment and/or be informed of insufficient account credit associated with the pet parent 420, and in some embodiments the PIMS user 416 processes a gap payment (e.g., via the platform 402) that was made from the pet parent 420 to the vet practice associated with the PIMS user 416. The payment gateway 414 may be used by the MGA system of the MGA systems 412 to directly make a payment to the vert practice, for example per the coverage associated with the pet parent 420. The PIMS user 416 may use the portal 408 to access the platform 402 to check information associated with the coverage details, check claims status, and/or the like. It should be appreciated, based on the above flow, that a veterinarian practice may initiate a claim, or an MGA associated with a pet parent may initiate a claim, each being processed via the platform as discussed herein.

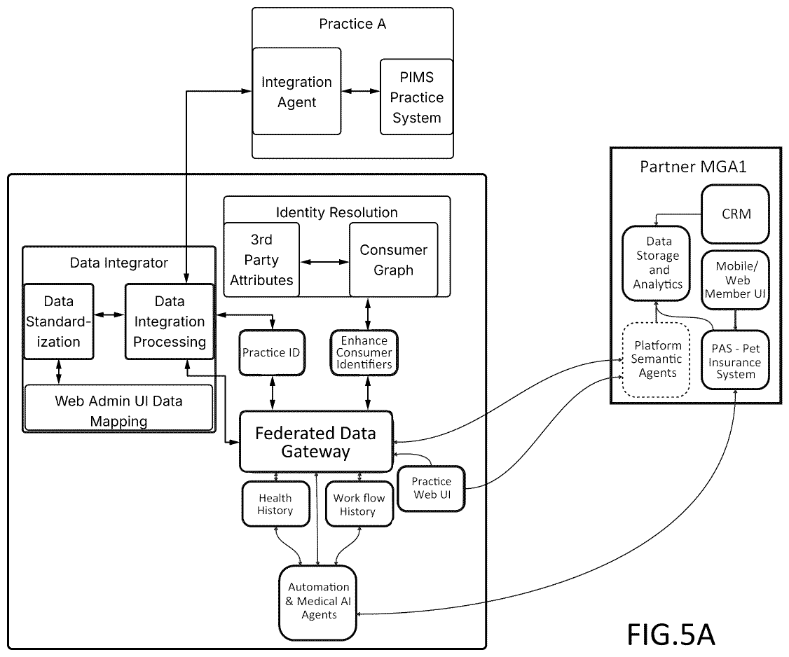

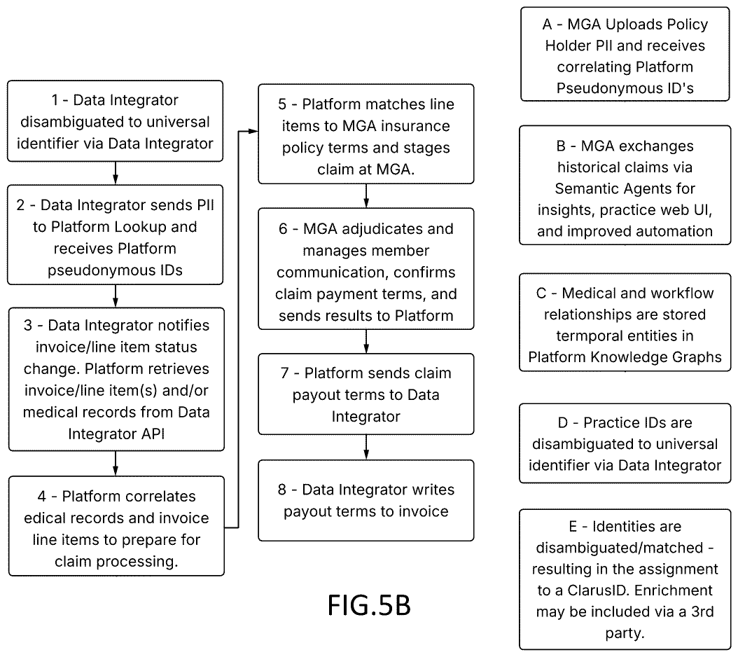

It should be understood that FIG. 4 illustrates just one example of a process which can be carried out by the platform (for example platform 200) and that many other animal health ecosystem transactions and/or processes and/or workflows can be performed using any single or combination of Partner systems within the ecosystem and participating in the platform 200/400, for example such as is shown in FIGS. 5A and 5B. The system of Practice A and the system of Partner MGA1 may be external systems communicatively coupled to one or more platform systems of the platform 200, for example “Clarus” systems that perform the distributed data synchronization and access discussed herein. Such systems in some embodiments include sub-components associated with the platform executing on the local system (e.g., native applications, web applications running through a browser, and/or the like), for example one or more integration agents of the Practice A and/or one or more Platform Semantic Agents of the Partner MGA1. In this regard, it should be appreciated that the data integrator, identity provider, federated data gateway, and automation & medical AI agents may be sub-components (e.g., embodied in software, hardware, firmware, and/or any combination thereof) of the Clarus system at the center of the platform (e.g., embodied by the apparatus 101C as depicted and described herein).

As depicted in FIGS. 5A and 5B, Systems of practice A (e.g., a PIMS practice system) integrate with a data integrator. The data integrator provides data standardization and web admin UI data mapping, and integrates with a federated data gateway for data synchronization (e.g., within a generated knowledge graph and/or with respect to one or more synchronized identifiers as described herein). In this regard, the synchronized data may be utilized to provide health history, work-flow history, and/or automation AI agents and/or medical AI agents. Additionally or alternatively, in some embodiments the federated data gateway enables the platform to provide a practice web UI for a particular practice (e.g., partner MGA1), such as to support one or more of platform semantic agents, pet insurance systems, data storage and analytics for the particular partner MGA, CRM data processing, and/or mobile or web member UI provision. In some embodiments, an identity provider of the platform provides enhanced consumer identifiers, for example by generating, deriving, and/or maintaining a synchronized identifier for a particular entity and linking knowledge graph information for that entity with the synchronized identifier accordingly). The synchronized identifier (e.g., a ClarusID) may be associated with a consumer graph and/or 3^{rd}-party attributes. Additionally or alternatively, in some embodiments the platform may send data to one or more of the other systems, for example claim payout terms to the data integrator via the federated data gateway of the platform. It should also be understood that the platform 200 capabilities include writing/sending information back to the partner systems (“Partners 402”), for example a partner Practice Information Management System.

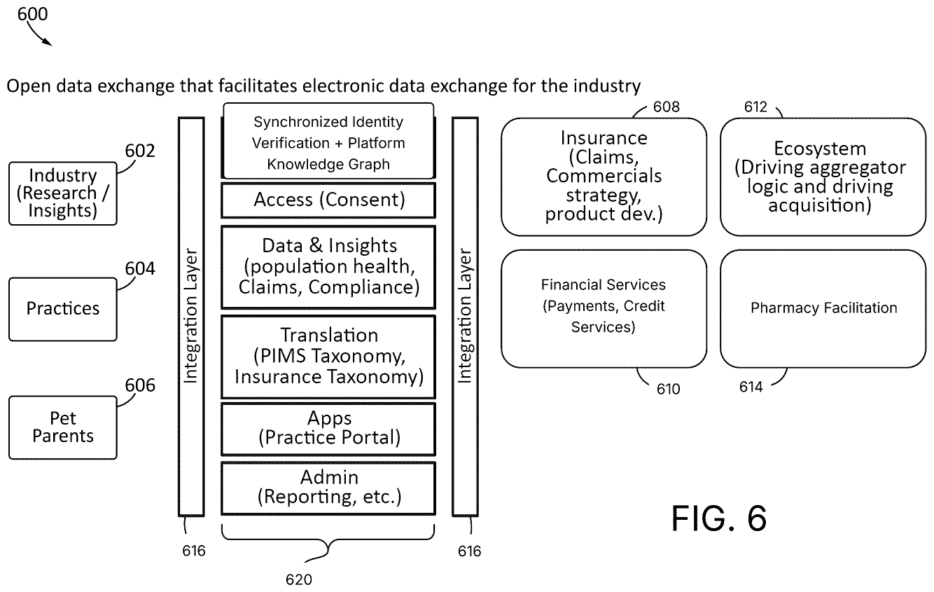

FIG. 6 is a concept drawing illustrating ecosystem platform 600 “marketecture” functionality and participants, in accordance with an exemplary embodiment of the present disclosure. Generally, certain platform partners (e.g. Industry 602, Practices 604, Pet Parents/Owners 606) are arranged on the left side of FIG. 6. Other platform partners (e.g. Insurance 608, Financial Services 610, Ecosystem (Driving aggregator logic and driving acquisition) 612, pharmacy 614) are arranged on the right side of FIG. 6. In some embodiments, Ecosystem 612 could be a “marketplace”-like partner who offers a comparison of different Partner offerings.

In the center is the platform technology subsystem 620 (e.g., the platform 150) where integration layers 616 standardize data coming to and from the platform technology subsystem 620, including synchronized identity verification (e.g., creation and/or maintenance of one or more ClarusIDs that uniquely represent data insights, events, or the like associated with a particular entity) and maintenance of a platform's knowledge graph that integrates various data associated with any one of an individual, system-specific identity of an entity into a combined representation of all such data, in an embodiment of the disclosure. As described elsewhere herein, the platform technology subsystem 620 performs various tasks/functions within the platform 600, examples being listed in FIG. 6. It should be understood that these are by way of example only. In some embodiments, the platform 600 is embodied by the platform 200, and/or particular subsystems thereof (e.g., the Platform Technology subsystem 220).

FIGS. 7A and 7B are a schematic diagram 700 showing interrelationships between data elements of various Partners participating in the platform, including data representing identities and/or information associated with a plurality of pet partners 702A-702B (collectively “owners 702”), a plurality of pets 704A-7004C (collectively “pets 704”), a plurality of claims 706A-706D (collectively “claims 706”), a plurality of policies 708A-708B (collectively “policies 708”), a plurality of system links 710A-710C (collectively “links 710”), a plurality of veterinary systems 712A-712B (collectively “vet systems 712”), and a plurality of MGA systems 714A-714B (collectively “MGA systems 714”), as well as exemplary actions between them, in accordance with an exemplary embodiment of the present disclosure. Such interrelationships represent data-driven relationships between various data points, data records, events, and/or, the like in synchronized data formed in a knowledge graph and integrated by the platform described herein, for example the platform 200 via the platform technology subsystem 220. FIGS. 7A and 7B specifically depicts a knowledge graph including data representations of events between system participants, specifically data representations of two pet “parents” (John and Sarah, of owners 702) , data representations of their pets Charlie, the golden retriever, Buddy the labrador, and Max the Persian cat of pets 704, and data representations of the various entities represented by vet systems 712A and MGA partners 714. Such events include claims 706 associated with the various pets 704 that were performed by particular entities represented by or otherwise associated with the vet systems 712, and/or claims processed by associated MGA partners represented by MGA systems 714. Such data additionally includes links 710 that identify different relationships between entities having shared but distinct data identifiers within different systems, for example a first identity in a first “VetSystem_A” and a second identity in a second “VetSystem_B”. In this regard, the platform may create a synchronized identifier (or ClarusID) for a particular entity based on any data determined to be with any one of the identifiers that represent the same entity. The platform maintains and/or records the temporal integrity of events between different partners/participants/actors for accurate current state management and/or historical state auditing.

In some embodiments, the platform maintains interrelationships between data elements of various partners/participants/actors participating in the platform as well as actions or events between them, including a temporal (time) dimension in some embodiments. Such interrelationships represent data-driven relationships between various data points, data records, events, and/or the like, in integrated data of the platform described herein, for example the platform 200 via the platform technology subsystem 220, further including a temporal dimension. In some embodiments, the interrelationships between data elements is determined based on uploading and/or ingesting of the data from a shared document, data source, and/or the like. In some other contexts, the interrelationships between data elements s determined using an AI agent, ML agent, and/or the like that determines an accuracy of linkages between data elements based on the available data associated with a particular entity or multiple entities. The addition of the temporal dimension (adding an extra dimension of time), allows for storing multiple versions of the same assertion to reflect changes over time, in some embodiments of the disclosure.

As an example of a workflow within the platform, a pet parent, for example “Julie”, creates an appointment using a vet practice management System for her dog. The vet practice management system communicates with the platform, for example via a platform federated data gateway or memory associated therewith (e.g., embodying or including the federated data gateway 222 depicted and described with respect to FIGS. 2A-2B) to identify Julie based on available data, which is determined and/or returned as a synchronized identifier (e.g., a ClarusID) uniquely linked to Julie and associated with the various data associated with Julie and/or her dog from any number of parties and/or systems with which she has interacted. An appointment is also stored via the platform federated data gateway with a valid timestamp of when the appointment was made. At the time of the appointment, Julie takes her dog to the appointment with the veterinarian. The veterinarian checks the dog's health and records the dog's breed and vitals into the vet practice management system, which is also linked and thus saved to the platform as “Julie Adopts Dog”. In a case where time information is unknown, it is not stored.

In an embodiment, the dog's appointment entry is then updated with an In-Valid timestamp, to represent that the appointment “entity” is no longer valid. It is important to note, that there is no general or standardized concept of a “visit” in the vet practice management system, so the platform federated data formed into a knowledge graph that uses temporal data to correlate events to a visit.

The veterinarian administers a rabies vaccine to the dog and records notes in the vet practice management system. These notes are retrieved by automation agents of the platform to interpret and transform that data into a standardized format, for example as a data link of “rabies vaccine” between the veterinarian and the dog in a knowledge graph, with a valid timestamp of when it was administered and an invalid timestamp of when the vaccine will expire.

The platform's automation agents will also check the platform (e.g., via a platform federated data gateway) to see if there is valid insurance coverage on the dog. In a circumstance where no insurance policy is found for this visit, “Incident Not Covered” is returned to the vet practice management system. The vet practice management system generates an invoice for the full amount and Julie “Pays Invoice.”

Continuing this example scenario, a second pet parent Jack may purchase an insurance policy with the insurance MGA policy admin system. The insurance MGA policy admin system may identify Jack as associated with a second identifier, or may identify that Jack and Julie are part of the same household (e.g., a shared synchronized identifier associated with both Jack and Julie) and stores Jack as a member alongside Julie and their dog. In some embodiments for example, the household may be assigned a shared synchronized identifier, which is linked to a synchronized identifier associated with Jack and also linked to another synchronized identifier associated with Julie. The insurance policy is stored in the platform with a valid timestamp that represents when the policy coverage begins and an invalid timestamp of when the policy coverage ends (if available).

After the coverage begins, Julie takes the dog to the veterinarian for scratching. The veterinarian checks the Dog's health and diagnoses an ear infection, then treats an ear infection. The veterinarian records the diagnosis and treatment in the vet practice management system.

These notes are retrieved by the Platform, for example via Automation Agents to interpret and transform that data into a standardized format, for example as “Treat ear infection” with a valid timestamp of when it was diagnosed and treated. The Platform Automation Agents will also check the platform (e.g., via a platform federated data gateway) to see if there is valid insurance coverage on the dog. The insurance policy is found for this visit, so the platform automation agents stage the information for a claim and submit to the insurance MGA policy admin system. In this case, the insurance MGA policy admin system messages Jack to confirm a claim is being filed on the dog 706 by Julie and he confirms that claim is legitimate with a reason for visit of “Scratching.”

The insurance MGA policy admin system then requests to have platform automation agents to “Automate Claim.” The platform automation agents complete the automation with information supplied by Jack and the MGA and then request validation from the insurance MGA policy admin system. The validation of the amount covered is sent from the insurance MGA policy admin system back to the platform automation agents, which then send that back to the vet practice management system with the amount the insurance company will pay.

The vet practice management system applies that to the invoice and then invoices the remainder as the “Gap” amount to Julie. Julie pays the invoice to the vet practice management system, which then confirms the gap amount was paid and requests the covered amount payment from the insurance MGA policy admin system, via the platform automation agent.

The platform automation agents store “Jack Opens a claim for Dog on Ear Infection” in the platform (e.g., via a platform federated data gateway) with a valid timestamp of when it was opened and an invalid timestamp of when it was validated. The insurance MGA policy admin system then pays the covered amount directly to the vet practice management system, and that payment is recorded in the platform federated memory.

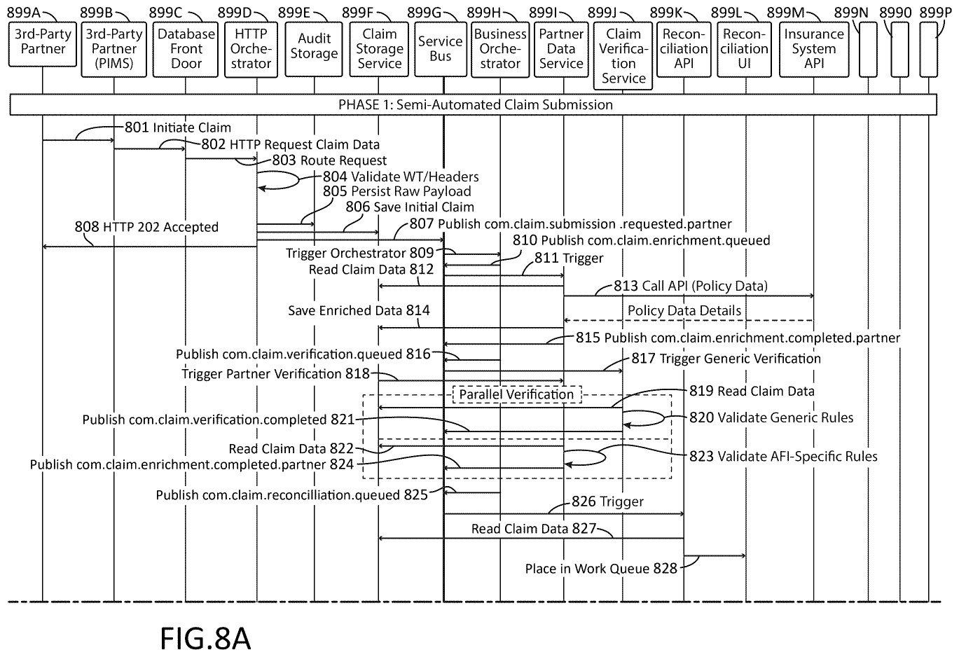

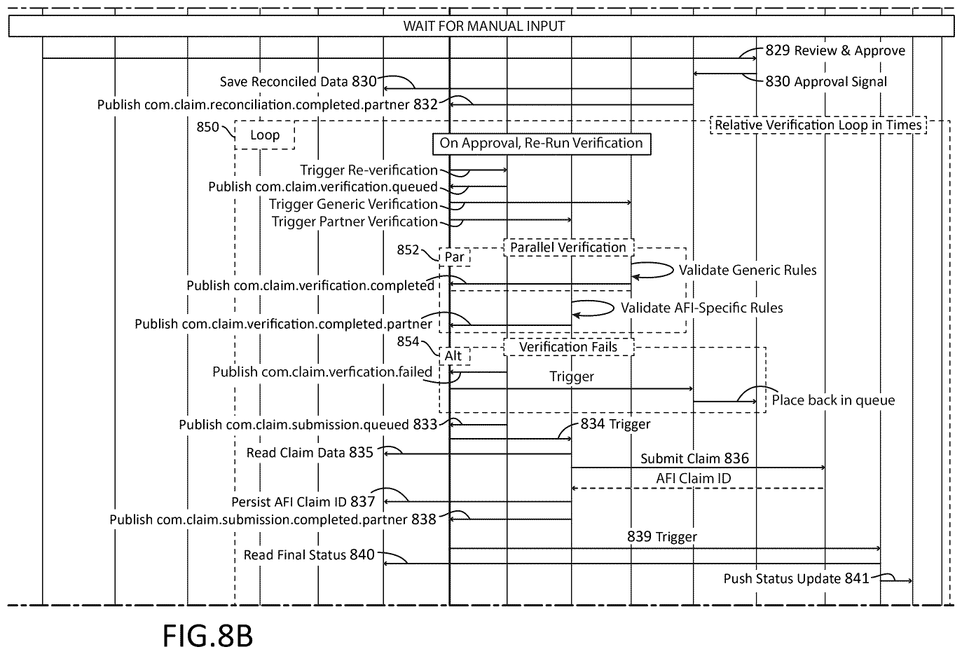

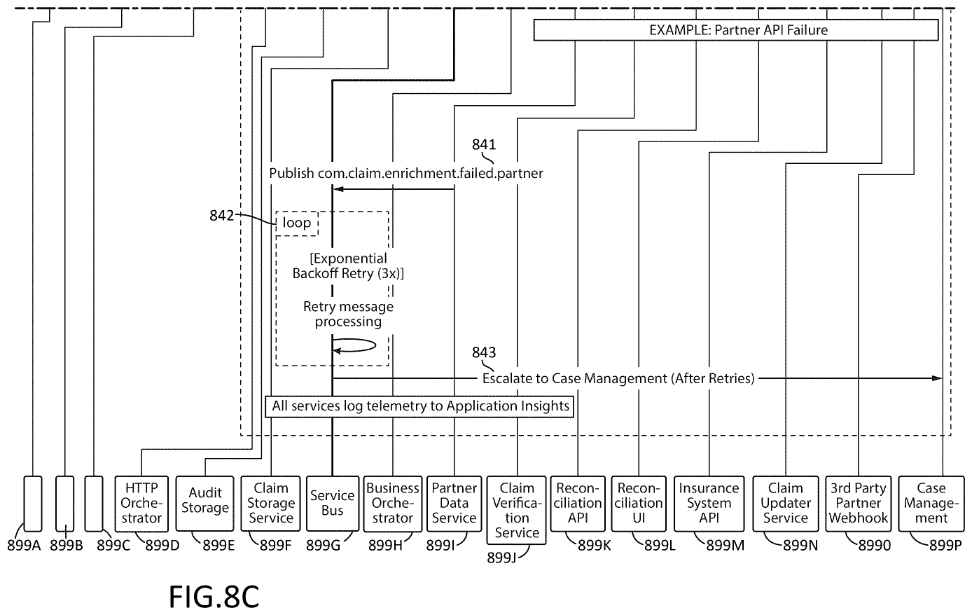

FIGS. 8A, 8B, and 8C depict a flowchart indicating steps of an example claims processing flow performed by the platform. For example, the flow in some embodiments represents the operations performed by an example system, for example the platform 200, to initiate and/or process, such as the claim submitted in accordance with the above example scenario. FIGS. 8A, 8B, and 8C specifically depict actions performed between a third-party partner user 899A, third-party partner PIMS 899B, database front door 899C, HTTP Orchestrator 899D, audit storage 899E, claim storage service 899F, service bus 899G, business orchestrator 899H, partner data service 899I, claim verifications service 899J, reconciliation API 899K, reconciliation UI 899L, insurance system API 899M, claims updater service 899N, third-party partner webhook 899O, and case management API 899P. Each of the systems and/or components 899A-899P may be embodied as a device, application, service, or other combination of hardware, software, and/or firmware.

At step 801, the third-party partner user 899A initiates a claim to the ICV PIMS 899b. At step 802, the third-party partner PIMS submits an HTTP request to the database front door 899C, for example which includes claim data. At step 803, the database front door 899C routes the request to the HTTP orchestrator 899D. At step 804, the HTTP orchestrator 899D validates the request (e.g., JWT and/or headers) to proceed. At step 805, the HTTP orchestrator persists the raw payload to the audit storage 899E. At step 806, the HTTP orchestrator saves the initial claim to the claim storage service 899F. In some embodiments, the claim storage service 899F includes or is embodied by a knowledge graph as discussed herein.

At step 807, the HTTP orchestrator publishes the requested claim submission to the service bus 899G, for example corresponding to the particular requested partner. At step 808, the HTTP orchestrator 899D indicates to the third-party partner PIMS 899B that the HTTP request was accepted, for example by sending an HTTP 202 accepted status code.

At step 809, the service bus 899G triggers a business orchestrator 899D. At step 810, the business orchestrator 899H publishes an enrichment request queued to the service bus 899G.

At step 811, the service bus 899G triggers the partner data service reads claim data from the claim storage service 899F (e.g., via a knowledge graph stored or maintained by the platform). The partner data service 899I reads the claim data from the claim storage service at step 812.

At step 813, the partner data service 899I calls an insurance system API 899M, for example for policy data associated with the claim. The insurance system API 899M in some embodiments returns such requested data in response.

In some embodiments, the partner data service 899I saves enriched data (e.g., based on the policy details returned from the insurance system) to the claim storage service 899F. At step 815, the partner data service 899I publishes that the claim enrichment has been completed. At step 816, the business orchestrator 899H publishes a verification request queued to the service bus 899G.

At step 817, the service bus 899G triggers a generic verification process to the claim verification service 899J. At step 818, the service bus 899G triggers partner verification to the partner data service 899I. In some embodiments, the verification processes are performed in parallel. For example, at step 819, the claim verification service 899J reads claim data from the claim storage service 899F. At step 820, the claim verification service 899J validates one or more generic rules with the claim data. At step 821, the claim verification service 899J publishes a generic claim verification complete notice to the service bus 899G. In parallel for example, at step 822, the partner data service 899I reads claim data from the claim data service 899F. At step 823, the partner data service 899I validates one or more API-specific rules with the claims data. At stop 824, the partner data service 899I publishes a partner-specific claim verification completion notice to the service bus 899G. In some embodiments, the parallel verification processes then end.

At step 825, the business orchestrator 899H publishes a claim reconciliation queue notice to the service bus 899G. At step 826, the service bus 899G triggers reconciliation API 899K. At step 827, the reconciliation API 899K reads claim data from the claim storage service 899F. At step 828, the reconciliation API 899K places the reconciliation request in the work queue of the reconciliation UI 899L

At step 829, the third-party partner user 899A reviews and approves a reconciliation via the reconciliation UI 899L. At step 830, an approval signal is sent from the reconciliation UI to the reconciliation API 899K. At step 831, the reconciliation 899K saves the reconciled data to the claim storage service 899F. At step 832, the reconciliation API publishes a claim reconciliation completion notice for the partner platform to the service bus 899G.

A loop 850 is performed, for example for iterative verification. In the loop, the service bus 899G triggers a re-verification process with the business orchestrator 899H. The business orchestrator 899H publishes a claim verification queued notice to the service bus 899G. The service bus 899G triggers a generic verification at claim verification service 899J. The service bus 899G triggers partner verification at the partner data service 899I. The verification processes in some embodiment occur in parallel, for example at parallel steps 852.

For example, as illustrated, the claim verification service 899J validates generic rules for verification. The claim verification service 899J publishes a generic claim verification completed notice to the service bus 899G upon completion. The partner data service 899I performs validation of partner-specific rules. The partner data service 899I publishes a partner-specific verification completed notice to the service bus 899G upon completion.

Alternatively, in a circumstance where the verification fails, an alternative failed verification process 854 is initiated. In some embodiments, business orchestrator 899H publishes a claim verification failed notice to the service bus 899G. The service bus 899G triggers the reconciliation API 899K. The conciliation API 899K places back in the queue the request to the reconciliation UI 899L.

At step 833, the business orchestrator 899H publishes a claim submission request queued notice. At step 834, the business orchestrator 899H triggers partner data service 899I. At step 835, the partner data service 899I the partner data service 899I reads claim data from the claim storage service 899F. At step 836, the partner data service 899I submits a claim to the insurance system API 899M, and the third-party partner claim ID is returned for example. At step 837, the partner data service 899I persists the third-party partner claim ID in the claim storage service 899F. At step 838, the partner data service 899I publishes a partner claim submission completion notice to the service bus 899G. At step 839, the service bus 899G triggers a claim updater service 899N. The claim updater service 899N reads a final status from the claim storage service 899F. At step 841, the claim update service 899N pushes a status update to the third-party partner webhook 899O.

In some embodiments, the partner API call fails, and one or more subsequent steps are performed. At step 841, the partner data service 899F publishes a partner claim enrichment failed notice to the service bus 899G. A loop process 842 is performed by the service bus 899D, for example for an exponential backoff retry threshold. For example, the service bus 899D in some embodiments retries message processing for a number of times. In a circumstance where the message retry fails, at step 843 the service bus 899D escalates to case management 899M.

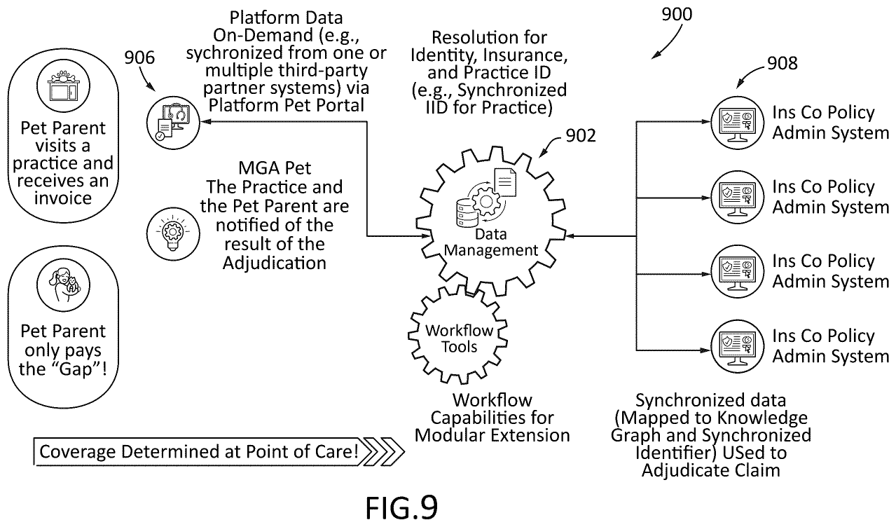

FIG. 9 depicts an example depiction of a workflow in which a platform as described herein is utilized for point of care coverage determination. Specifically, FIG. 9 depicts an example workflow 900. The workflow 900 may be performed by an example platform, such as the platform 150 as depicted and described herein, specially configured to provide the described functionality with respect to point of care coverage determination.

As illustrated, a pet parent may visit a practice (e.g., a veterinarian provider) and receive an invoice for services performed on their pet. Platform data via the platform 150 may be made available, for example where such data is synchronized from one or multiple third-party partner systems at 906. For example, such data may be synchronized via the knowledge graph and/or synchronized identifier (e.g., ClarusID) as described herein. Such data (e.g., on-demand data of the synchronized data for a particular ClarusID or multiple ClarusIDs) are processed via data management 902, where a resolution for the identity, insurance, and practice ID is determined. Workflow capabilities may be implemented that provide this resolution, and the Practice and Pet Parent partners may each be notified of the results of the resolution (e.g., the adjudication) via their respective systems accordingly. The synchronized data (e.g., mapped to the knowledge graph based on synchronized identifier(s) as described herein) is used to adjudicate the claim via processing by one or more insurance company policy administration systems 908. In this regard, a coverage determination in some such embodiments is made at a point of care utilizing the platform 150. The flow then completes.

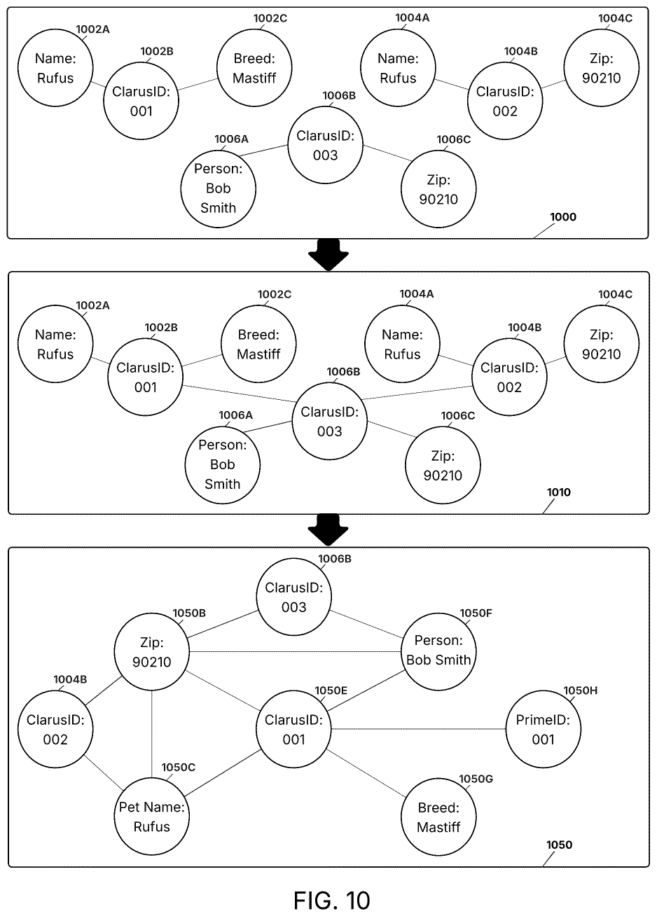

FIG. 10 is an example diagram depicting formation of a knowledge graph for data of a particular entity using data subsets associated with different synchronized identifiers, in accordance with at least an exemplary embodiment of the present disclosure. Specifically, FIG. 10 depicts formation (or otherwise, generation in a computing system) of a knowledge graph through processing of distinct, imported data subsets, for example which may be imported from any of a myriad of distinct partner systems. The figure depicts an initial stage 1000, in which the data subsets are represented as distinct graph subsets, an intermediary stage 1010, in which the data subsets are connected as representing data associated with a shared entity (or entities), and a subsequent stage 1050, in which distinct data portions are synchronized.

As depicted at stage 1000, distinct data sets may be imported or otherwise ingested by the system (e.g., the Clarus platform embodied by the apparatus 101C, for example). In some embodiments, the data records are imported from a plurality of different partner systems. For example, first data may be imported from a veterinarian services system, where such data records are imported and form the nodes 1002A, 1002B, and 1002C to form a first sub-graph of data associated with an entity derived from such third-party data records. The data records are associated with a pet name “Rufus” and a breed for the pet of “Mastiff”. Nodes corresponding to such insights are generated within the knowledge graph and linked to a node corresponding to a particular generated synchronized identifier for such data, specifically “ClarusID 001.” The edges between the nodes in some embodiments represent relationships determined between the data of connected nodes, for example an “is associated with” relationship or a more defined relationship representing determined knowledge between the connected nodes (e.g., “lives in/at”, “is breed”, “is owned by”, and/or the like). The data of the first subgraph and/or relationships between such nodes in some embodiments all correspond to a particular event, for example a particular interaction with the entity corresponding to the partner system. It should be appreciated that to avoid visual clutter and to enhance the readability of the figure, not all relationships are depicted between nodes depicted and described with respect to FIG. 10, however embodiments of the present disclosure nevertheless may form and/or maintain such relationships.

A second type of data, for example other third-party data, may be imported from a different partner system, such as a pet services (e.g., a pet daycare) system, where such data records are imported and form the nodes 1004A, 1004B, and 1004C. Such nodes form a second sub-graph of data associated with the entity and derived from such third-party data records. The data records are associated with a pet named “Rufus” and a zip code for the pet of “90210”. Nodes corresponding to such insights are generated within the knowledge graph and linked to a node corresponding to another synchronized identifier for such data, specifically “ClarusID 002”. The edges between the nodes in some embodiments represent relationships between such data as well.

A third type of data, for example other third-party data, may be imported from yet another partner system, such as an MGA system, where such data records are imported and form the nodes 1006A, 1006B, and 1006C. Such nodes form a third sub-graph of data associated with the entity and derived from such third-party data records. The data records are associated with a person named “Bob Smith” and a zip code for Bob Smith of “90210”. Nodes corresponding to such insights are generated within the knowledge graph and linked to a node corresponding to another synchronized identifier for such data, specifically “ClarusID 003”. The edges between the nodes in some embodiments represent relationships between such data as well. It should be appreciated that the three data sub-sets are distinct from one another at stage 1000.

At stage 1010, embodiments of the present disclosure process the various sub-sets of data to link the nodes associated with such sub-graphs. In some embodiments, the Clarus platform initiates synchronization to link various related data sets together in response to certain trigger conditions. In some implementations, such synchronization is performed at defined time intervals (e.g., every X minutes, every hour, and/or the like). In some implementations, such synchronization is performed in response to detection of a particular event (e.g., upon completion of importation of new data, detection of a registered event, and/or the like).

At step 1010, the Clarus platform links the various synchronized identifiers together, specifically ClarusIDs 001, 002, and 003 (reference characters 1002B, 1004B, and 1006B). The linked nodes of the ClarusIDs represent that the ClarusIDs correspond to the same entity or a same meta entity (e.g., a pet owner is one entity, and their dog may be a sub-entity with a relationship of “owned by”). The Clarus platform, for example embodied by the apparatus 101C, may utilize one or more specially configured automation agents, AI models, ML models, and/or other algorithms specially configured to form the relationships between such nodes and/or sub-graphs. For example, in some embodiments the Clarus platform looks at the contents of information in a sub-graph (e.g., data values and/or relationships between the data values), and processes such data to determine how to connect edges between the various nodes. In this regard, such processing is a deterministic and event-based matching process that forms the linkages between data sub-graphs that are unique to different events and/or entities, thus identifying and deterministically joining distinct data associated with the same entity. Such processing in some embodiments results in the joining of ClarusIDs associated with Rufus (e.g., ClarusIDs 001 and 002) via a link with ClarusID 003 corresponding to Rufus' determined owner, Bob Smith. The resulting graph connects the data for a single entity and connects related entities accordingly

At step 1050, the Clarus platform generates a simplified knowledge graph based on the data and relationships defined by edges and nodes at the previous step. The resulting data forms a knowledge graph including nodes of derived or imported information, relationships between entities represented by nodes in the knowledge graph, and the like. In this regard, the knowledge graph may represent useful, data-driven insights derived from such data, relationships therebetween, and/or the like. For example, as illustrated, each of the aspects 1050B, 1050F, 1050C, and 1050G relating to the pet “Rufus” is linked to the “ClarusID 001,” for example where a “lives at” relationship connects the ClarusID node 1050E to the zip node 1050B, a “is named” relationship connects the ClarusID node 1050E to the name node 1050C, a “is owned by” relationship connects the ClarusID node 1050E to the person node 1050F, and a “is breed” node connects ClarusID node 1050E to the breed node 1050G. In some embodiments, the ClarusID utilized for connecting the various other nodes associated with an entity may be determined based on which node (or corresponding event, trigger, and/or the like) occurred earliest in time. In some embodiments, such an earliest (or otherwise determined) ClarusID 001 is assigned as a PrimeID in the PrimeID node 1050H. A knowledge graph may be queried by a user (e.g., a third-party provider system) starting from a ClarusID, for example, to identify and/or retrieve data associated with the request and particular ClarusID, links associated therewith, and/or other data and insights determinable via traversal of the knowledge graph beginning from a particular node (e.g., the ClarusID available to the partner system). In this regard, in some embodiments, the knowledge graph may be formed directionally or semi-directionally, such that querying based on nodes for ClarusIDs corresponding to a more narrow scope of information yields less information than querying from a higher-level or root node associated with an entity in the knowledge graph. It should be appreciated that querying different ClarusIDs in this manner similarly allows more narrowed queries to resolve at a faster rate than broader queries that begin from a higher level or root node. In some embodiments, the PrimeID is a node assigned corresponding to a particular ClarusID node, which may be used to indicate a particular top level (or earliest added) node for a particular entity. In this regard, the PrimeID node 1050H may be utilized to perform a more comprehensive and/or general query associated with data for a particular entity.

In some embodiments, a particular partner or other participant receives a ClarusID when data from the partner is ingested by the Clarus platform. The partner system may utilize that ClarusID to query the Clarus platform. For example, in a circumstance where a partner queries for knowledge associated with such data or related data added to the knowledge graph, for example other data similarly associated with the same entity, a partner may utilize the ClarusID to query beginning from a particular node and receive or otherwise identify data linked to that ClarusID in the knowledge graph or present in a sub-graph linked to that ClarusID. In this regard, the ClarusID may both be used to link data associated with one another as well as to define a scope for processing and/or querying data associated with one or more entities. Additionally or alternatively still in some embodiments, access permissions may be applied to certain data, Clarus identifiers, or other definable scopes. In this regard, a definable scope associated with a user, data node, ClarusID, and/or the like, may enable only certain users to access such data via the knowledge graph, for example whether accessed directly or via querying up and/or down the knowledge graph. A scope may be defined based on configurations set by the data owner, geographically-defined, defined by a data regulator or other authoritative body, and/or the like. Using such scopes, a knowledge graph may be configured such that users associated with different Partners “can see” different data from the same knowledge graph. It should be appreciated that the ClarusIDs (e.g., synchronized identifiers) are interoperably usable by various Partners, such that a plurality of Partners may be permissioned to query a particular ClarusID and receive data associated with the ClarusID even if they are not the original source of the data associated with the ClarusID.

A generated knowledge graph may be usable for any of a myriad of data-driven insights. In one example context, a generated knowledge graph (or a temporal knowledge graph) is usable for efficient claims processing. For example, data associated with one or more ClarusIDs may be queried associated with a particular claim event. The query may be processed to determine the available data associated with the claim, a corresponding event, involved entities, an applicable scope of insurance coverage, and/or the like, where such elements embody data insights and/or values in the knowledge graph and linked via one or more synchronized identifiers (e.g., ClarusIDs). The temporal element may further be introduced to capture time-relevant data from the knowledge graph and ignore data that is not pertinent to the relative time frame (e.g., data that occurred after a claim event, for example). The use of the knowledge graph including various synchronized identifiers allows a Partner to more efficiently begin a query closer to a nexus of data that is relevant to a particular use case being performed, thus reducing query execution time and saving computing resources for performing the query as well as reporting any relevant results.

It is expected that during the life of a patent maturing from this application many relevant AI technologies will be developed and the scope of the term AI is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the embodiments disclosure have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A distributed data synchronization and access platform, comprising:
at least one platform technology subsystem, wherein the at least one platform technology subsystem is in operative communication with a plurality of partner systems,
wherein the at least one platform technology subsystem is configured to intake data from each partner system of the plurality of partner systems and distribute data to each partner system of the plurality of partner systems, wherein the data intake and the data distribution performed by the platform technology subsystem is agnostic to data content utilized by each partner system of the plurality of partner systems, and
wherein the at least one platform technology subsystem is configured to:
generate one or more synchronized identifiers corresponding to one or more subsets of data associated with an entity, wherein each synchronized identifier of the one or more synchronized identifiers correspond to a data subset of the one or more subsets of data associated with the entity; and
store, based on the one or more subsets of data associated with the entity, centralized integrated data, wherein the centralized integrated data is stored in a knowledge graph generated based on the one or more synchronized identifiers.

2. The distributed data synchronization and access platform of claim 1, wherein the platform technology subsystem comprises:
a federated data gateway; and
one or more computing agents,
wherein the federated data gateway provides a data interlink between at least one of the one or more computing agents and at least one of the plurality of partner systems.

3. The distributed data synchronization and access platform of claim 1, wherein the platform technology subsystem comprises:
a federated data gateway; and
one or more computing agents,
wherein the federated data gateway provides a data interlink between different computing agents of the one or more computing agents.

4. The distributed data synchronization and access platform of claim 1, wherein the platform technology subsystem comprises one or more computing agents, the one or more computing agents comprising:
an automation agent, or
a medical record AI agent, or
a temporal knowledge graph agent, or
a partner web UI agent, or
a normalization agent, or
a workflow logic agent, or
a simulator and admin configuration agent, or
a summarization and inference agent, or
a combination thereof.

5. The distributed data synchronization and access platform of claim 1, wherein the at least one platform technology subsystem comprises:
at least one temporal knowledge graph agent that is configured to generate the knowledge graph comprising a temporal knowledge graph from the centralized integrated data, wherein the temporal knowledge graph accounts for disparate data points from different partner systems of the plurality of partner systems and represented in the centralized integrated data.

6. The distributed data synchronization and access platform of claim 5, wherein the at least one platform technology subsystem comprises:
at least one relationship links agent that manages relationships between the one or more synchronized identifiers in the temporal knowledge graph.

7. The distributed data synchronization and access platform of claim 1, wherein the at least one platform technology subsystem comprises:
at least one computing agent, wherein the at least one computing agent is configured to output a determination value based on at least a portion of the centralized integrated data in the knowledge graph.

8. The distributed data synchronization and access platform of claim 1, wherein to intake the data from each partner system of the plurality of partner systems, the platform technology subsystem is configured to generate the centralized integrated data comprising one or more data episodes comprising one or more timestamped entity relationships and one or more facts derived through at least one normalized data container.

9. The distributed data synchronization and access platform of claim 1, wherein the at least one platform technology subsystem is configured to provide access to at least one service based on the data or requirements taken in from each partner system, the centralized integrated data, or data derived from the data taken in from each partner system or the centralized integrated data.

10. The distributed data synchronization and access platform of claim 1, wherein the knowledge graph comprises at least one node representing the entity and further comprising an interconnection representing a relationship between the entity and another entity, a relationship between the entity and a data value associated with the entity, or representing an event associated with the entity and another entity.

11. A method of using distributed data synchronization and access platform, comprising:
receiving, at a platform technology subsystem of the distributed data synchronization and access platform, a plurality of intake data, wherein the plurality of intake data comprises data from each of a plurality of distinct partner systems;
generating, by the platform technology subsystem, a knowledge graph comprising centralized integrated data based on the plurality of intake data from the plurality of distinct partner systems, the centralized integrated data corresponding to one or more synchronized identifiers associated with an entity;
storing, by the platform technology subsystem, the centralized integrated data; and
distributing, by the platform technology subsystem, at least a portion of data based on the centralized integrated data in the knowledge graph to at least one of the plurality of distinct partner systems.

12. The method of claim 11, wherein the platform technology subsystem performs the receiving of the plurality of intake data and the distributing of at least the portion of data based on the centralized integrated data agnostic to data content utilized by each partner system of the plurality of partner systems.

13. The method of claim 11, wherein the platform technology subsystem comprises a federated data gateway, wherein the federated data gateway provides a data interlink that receives the plurality of intake data.

14. The method of claim 11, wherein the one or more synchronized identifiers are interoperably accessible by multiple of the plurality of distinct partner systems.

15. The method of claim 11, wherein the platform technology subsystem generates the centralized integrated data using one or more of:
an automation agent, or
a medical record AI agent, or
a temporal knowledge graph agent, or
a partner web UI agent, or
a normalization agent, or
a workflow logic agent, or
a simulator and admin configuration agent, or
a summarization and inference agent, or
a combination thereof.

16. The method of claim 11, further comprising:
generating, by at least one temporal knowledge graph agent of the platform technology subsystem, the knowledge graph comprising a temporal knowledge graph from the centralized integrated data, wherein the temporal knowledge graph accounts for distinct data points from different partner systems of the plurality of distinct partner systems and represented in the centralized integrated data.

17. The method of claim 16, further comprising:
managing, by at least one relationship links agent of the platform technology subsystem, one or more relationships between nodes associated with distinct data entities in the temporal knowledge graph.

18. The method of claim 11, further comprising:
outputting, by at least one computing agent of the platform technology subsystem, a determination value based on the centralized integrated data.

19. The method of claim 11, wherein generating the centralized integrated data comprises generating the centralized integrated data comprising one or more data episodes comprising one or more timestamped entity relationships and one or more facts derived through at least one normalized data container.

20. The method of claim 11, further comprising:
providing, by at least one computing agent of the platform technology subsystem, access to at least one service to at least one of the partner systems, wherein the at least one service is provided based on the data captured within the knowledge graph.

21. A non-transitory computer-readable storage medium comprising computer-coded instructions stored thereon that, in execution with at least one processor, configure the at least one processor for:
receiving, at a platform technology subsystem of the distributed data synchronization and access platform, a plurality of intake data, wherein the plurality of intake data comprises data from each of a plurality of distinct partner systems;
generating, by the platform technology subsystem, a knowledge graph comprising centralized integrated data based on the plurality of intake data from the plurality of distinct partner systems, the centralized integrated data corresponding to one or more synchronized identifier associated with an entity;
storing, by the platform technology subsystem, the centralized integrated data; and
distributing, by the platform technology subsystem, at least a portion of data based on the centralized integrated data in the knowledge graph to at least one of the plurality of distinct partner systems.

22. The non-transitory computer-readable storage medium of claim 21, wherein the computer-coded instructions further configure the at least one processor for:
generating, by at least one temporal knowledge graph agent of the platform technology subsystem, the knowledge graph comprising a temporal knowledge graph from the centralized integrated data, wherein the temporal knowledge graph accounts for distinct data points from different partner systems of the plurality of distinct partner systems and represented in the centralized integrated data.
